(19) United States
(12) Patent Application Publication
(10) Pub. No.: US 2005/0038683 A1
(43) Pub. Date: Feb. 17, 2005

(54) System and method of international patent application

(76) Inventor: Young-hee Leem, Seoul (KR)

Correspondence Address: Young Hee Leem, 1018 23 Sadang Dong, Dongjak Gu, Seoul, 156 091, KR

(21) Appl. No.: 10/496,405

(22) PCT Filed: Nov. 15, 2002
(86) PCT No.: PCT/KR02/02139

(30) Foreign Application Priority Data
Nov. 15, 2001 (KR) 2001-70933

(51) Int. Cl. G06F 17/60

(52) U.S. Cl. 705/7; 705/26

(57) ABSTRACT

The characteristic of the present invention is that it enables the intellectual property information, which has been filed in one patent office, also to be filed for international patent application in other patent office and/or to be on various electronic trades at a lower cost and efficient manner in cooperation with other country resident. More specifically, this invention enables specific intellectual property information filed for patent in at least one patent office to be filed in other requested country not by the original applicant or inventor of filed patent application but by requested country resident in his/her name and/or responsibility for his/her profit in accordance with contract terms.

### TECHNICAL FIELD

The present invention relates to system and method for filing international patent application of intellectual property information through communication network, and more particularly to system and method in which user can file the patent application of an intellectual property information already filed in one country through communication network cheaply and conveniently in other countries and that provides an useful platform for electronic commerce of intellectual property information between nations.

2. Background Art

The intellectual property information including patent, utility model, design, trademark, etc. which has been filed for patent rights in one country can be recognized to have been filed in other country on the same day if it is filed in other country within a period predetermined by international treaty like Paris Convention and PCT (Patent Cooperation Treaty), claiming prior application as a priority data. And intellectual property rights can be protected as patent rights according to each country's patent institution. So if intellectual property information is to be used successfully from commercialization point of view, it is preferable to be patented at least in related countries including applicant's motherland. Having obtained patent rights only in one country and making use of exclusive rights on its field only within that country while allowing the invention to be used without license in other countries in which it has not been filed for patent, may result in harms to the international competitive power of the country in the field because of patent institution. For which reason it is not reasonable and is difficult to exercise monopoly within only one country. Especially in Internet business circumstances if one electronic store using the invention patented for only one small country competes in world market with other electronic store located in other big country like U.S.A, China or E.U in which the same invention has not been filed for patents, the former store is likely to be defeated after all. In which case said issued patent is useless from commercialization point of view, and it is more desirable from individual inventor's or small company's point of view, assigning rights of filing patent application in foreign countries to someone freely so as to prevent from the product using the invention being sold very cheaply in foreign countries than many can use said invention freely and there in world market is excessive competition between competitors. Which case is especially applied to Internet based electronic commerce business where obtaining patent in various related countries is very important. But in prior art, obtaining patent for the intellectual property information, which have already been applied to one country for patent, in other countries needs not also to spend much expense but also to have considerable information concerning technology trend, patent institution, patent examination rules or criteria, etc. of the countries and commercialization possibility in the countries and also even to be ready suffer failure. For which reason it is more difficult for individual inventor to file patent application in foreign countries than company, etc. So most of filing patent application in foreign countries is done by global size big companies that can afford patent related expense and can obtain patent related information more easily. But in even such big companies it is not easy to apply to many countries if the invention is not related to original (source) technology and/or is not assured to obtain patent. And even if it has obtained patent with much expense, it is not easy to protect the issued patent from infringement because the patentee is not a resident. So if there occurs a lawsuit resulting from patent case, a foreign patentee is more likely to be placed at a disadvantageous position than a resident.

Generally in prior art of this field, filing international patent application under PCT procedure is done through the process comprising following steps of:
filing patent application in the mother country;
filing PCT patent application in WIPO, claiming prior application data; and
filing translation version application in all designated countries within 20, 30 or 31 months from priority filing date as national phase; and said process further comprising the step of submitting translated version for public disclosure to WIPO if needed.

And patent institutions are different from between designated countries among which there are countries where foreigner should file patent application only through a resident representative like patent agent, and countries like Korea where one can file it without demand of examination of application in first filing procedure. Also there may be differences in the technology level and market circumstance related to the invention between countries, so an inventor should consider possibility of commercialization for the invention, prior to filing patent application in each country, and should appropriately cope with prosecution opinion of patent office on patent application in the prosecution procedure. For that reason an inventor who wants to file international patent application may have more risk of loss and expense than in domestic application case. Which may be the chief reason that many inventors abandon the rights for filing application in oversea countries. Therefore there requests to developing technology to solve the above mentioned problems resulting from the prior art, and thereby for individual (institute) or small size company to be able to file patent application in many countries at a lower cost and conveniently.

Prior relevant invention includes E.P. Publication No. EP 0 940 762 A2, entitled MULTILINGUL PATENT INFORMATION SEARCH SYSTEM, PCT Publication No. WO 00175851 A1, entitled SYSTEM AND METHOD FOR VALUATING PATENTS, PCT Publication No. WO 01/02987 A2, entitled WEB-BASED INFOMEDIARY FOR INTELLCTUAL PROPERTY TRANSFER and PCT Publication No. WO 00/55791 A2, entitled OLINE PATENT AND LICENSE EXCHANGE.

### DISCLOSURE OF INVENTION

An object of the invention is to provide a technology to file patent application for intellectual property information, which has been filed in one patent office, in foreign country at a lower cost and conveniently.

Another object of the invention is to provide a technology that facilitates to protect obtained patent rights from infringement or attack in foreign country as perfectly as in motherland.

Another object of the invention is to provide a technology that facilitates electronic commerce of intellectual property information that has been filed in one patent office between countries.

Another object of the invention is to provide a useful means as platform that facilitates to attract fund and partners from the world, needed to commercialize the intellectual property information.

Another object of the invention is to provide a useful means as platform that supports filing patent application in various countries at a lower cost and conveniently and early commercialize intellectual property information.

Another object of the invention is to provide a technology that facilitates to promote the public recognition of intellectual property information in global market at a lower cost and conveniently.

(Advantages of the Invention)

The characteristic of the present invention is that it enables the intellectual property information, which has been filed in one patent office, also to be filed for international patent in other patent office at a lower cost and efficient manner and/or to be on various electronic trades including dealing, exchanging, licensing, etc., in cooperation with other country resident.

More specifically, the characteristic of the invention is that it enables specific intellectual property information filed for patent in at least one patent office to be filed in other requested country not by the original applicant or inventor of filed patent application but by requested country resident in his/her name and/or responsibility for his/her profit in accordance with contract terms.

Another characteristic of the invention is that it provides means for using other's intellectual property information cheaply by consumer as counterpart contractor including resident in foreign country.

Another characteristic of the invention is that since intellectual property information is filed for patent in the requested foreign country, not by the original applicant or inventor of the priority patent application, but by the resident consumer as counterpart contractor of the requested country who wants to practice the invention, said consumer can cope with the examination (prosecution) procedure on the patent application better than the original applicant (or inventor) can.

Another characteristic of the invention is that since the decision on whether to commercialize specific intellectual property information in requested foreign country or not is mainly made by the requested country resident consumer on his/her responsibility, the burden born by the original applicant (or inventor) resulting from said decision can be less than in prior art.

Another characteristic of the invention is that the cost for filing the patent application in specific foreign country can be paid, not by the original applicant (or inventor), but by the consumer as counterpart contractor of the intellectual property information.

Another characteristic of the invention is that the invention can be filed in various countries without restriction on the number of filed countries resulting from cost for fling as in prior art.

Another characteristic of the invention is that if the patent application is filed without demand of examination in filing stage, the examination procedure can be demanded by consumer as counterpart contractor of the invention as paying the examination demand fee on behalf of the original applicant.

(Brief Summary of the Invention)

The invention provides technologies used for filing international patent application of non-disclosed intellectual property information and/or disclosed intellectual property information respectively in other way in consideration of the method for best protection of intellectual property information.

Said non-disclosed intellectual property information is filed for patent through the cooperative company predetermined by the service system according to requested filing countries, and said disclosed intellectual property information is filed for patent through the consumer as contractor of contract of the specific intellectual property information who is selected among many potential consumers of said specific intellectual property information in auction manner and/or reverse-auction manner through means provided by the service system of the present invention.

The technology of filing international patent application for said non-disclosed intellectual property information is embodied as the following system.

A system for filing patent application of intellectual property information in foreign countries including user terminals and computer-implemented service system connected with Internet,
said service system receives from said user terminals a request for filing patent application in requested country together with an electronic version of non-disclosed intellectual property information including patent application file in non-disclosed manner and files in cooperation with the cooperative company located in the related country;
wherein said user has membership in said service system and membership information is registered in the storage device associated with said service system,
said non-disclosed intellectual property information relates to one of patent, design patent, trademark and utility model,
said cooperative company agrees with other companies to provide said users with international patent service through the service system of the present invention linked with each other via Internet.

The technology of filing international patent application for said non-disclosed intellectual property information is embodied as the following method.

A method, implemented using the system including user terminals and computer-implemented service system connected with Internet, for filing patent application of intellectual property information in foreign countries, comprising the steps of:
(a) receiving from said user terminals a request for filing patent application in one or more foreign country together with an electronic version of non-disclosed intellectual property information;
(b) receiving from said user the patent application fee for said intellectual property information filing and the service fee based on each filing service of said service system; and
(c) making contract of filing patent application in requested country and fulfilling the contract through the cooperative company located in the related country;
The technology of filing international patent application for said non-disclosed intellectual property information is embodied as a computer-readable storage medium containing the computer program for controlling the operation of computer processor in computer system to execute said method of filing international patent application for said non-disclosed intellectual property information

Also the technology of filing international patent application for said disclosed intellectual property information is embodied as the following system.

A system for filing patent application of intellectual property information in foreign countries including user terminals and computer-implemented service system connected with Internet, said service system comprising:
(a) means for electronically receiving the supply information of intellectual property from said user terminal, registering into the storage device and providing to said user terminals;
(b) means for electronically receiving the demand information of specific intellectual property from said user terminal, registering into the storage device and providing to said user terminals;
(c) means for electronically selecting contractors for electronic commerce contract of specific intellectual property information; and
(d) means for electronically making contract for electronic commerce of said specific intellectual property information and fulfilling said contract;
wherein said Intellectual property supply information relates to one of patent, design patent, trademark, utility model, and comprises filed application information in one or more country, bibliographic information of said application and/or contract terms for electronic commerce,
wherein said intellectual property demand information relates to the contract terms corresponding to said registered specific Intellectual property supply information or the contract terms including the identification information and the reward information for the specific intellectual property information not registered yet in said service system to be provided based on buyer initiative auction,
wherein the language used for the supply and demand information of said intellectual property information and for said contract comprises English.

Also the technology of filing international patent application for said disclosed intellectual property information is embodied as the following method.

A method, implemented using the system including user terminals and computer-implemented service system connected with Internet, for filing patent application of intellectual property information in foreign countries, comprising the steps of:
(a) electronically receiving the supply information of intellectual property from said user terminal, registering into the storage device and providing to said user terminals;
(b) electronically receiving the demand information of specific intellectual property from said user terminal, registering into the storage device and providing to said user terminals;
(c) electronically selecting contractors for electronic commerce contract of specific intellectual property information; and
(d) electronically making contract for electronic commerce of said specific intellectual property information and fulfilling said contract;
Also the technology of filing international patent application for said disclosed intellectual property information is embodied as a computer-readable storage medium containing the computer program for controlling the operation of computer processor in computer system to execute said method of filing international patent application for said disclosed intellectual property information.

### BRIEF DESCRIPTION OF DRAWINGS

FIG. 1 is a block diagram of the system of the first embodiment of the present invention.

FIG. 2 is a device block diagram of service system configuration of the present invention with respect to FIG. 1.

FIG. 3a is a detailed block diagram of control module with respect to FIG. 2.

FIG. 3b is a block diagram for a user terminal configuration with respect to FIG. 1.

FIG. 4 is an exemplary initial home page of control module with respect to FIG. 3a.

FIG. 5 is an exemplary searching web page for intellectual property supply information with respect to FIG. 4.

FIG. 6 is an exemplary reviewing web page of registered specific intellectual property supply information with respect to FIG. 5.

FIG. 7 is an exemplary registering web page of specific intellectual property supply information with respect to FIG. 5.

FIG. 8 is a linking diagram between web page and DATABASE in the first embodiment of the system of the present invention with respect to FIG. 1.

FIG. 9 is an exemplary searching web page of intellectual property demand information with respect to FIG. 4.

FIG. 10 is an exemplary reviewing web page of registered specific intellectual property demand information with respect to FIG. 9.

FIG. 11 is an exemplary registering web page of specific intellectual property demand information with respect to FIG. 9.

FIG. 12 is an exemplary web page personalized for each registered user with respect to FIG. 4.

FIG. 13 is an exemplary web page for selecting counterpart contractor for contract with respect to FIG. 3a.

FIG. 14 is an exemplary web page of contract document for filing patent application of intellectual property information with respect to FIG. 3a.

FIG. 15 is a block diagram of the system of the second embodiment of the present invention.

FIG. 15a is a diagram illustrating data linking between various service systems classified by country or language with respect to FIG. 15.

FIG. 15b is a linking diagram between web page and DATABASE in the second embodiment of the system of the present invention with respect to FIG. 15.

FIG. 16 is a whole block diagram of the system of the third embodiment of the present invention.

FIG. 16a is a diagram illustrating data linking between one unified contents providing server and various service systems classified by country or language with respect to FIG. 16.

FIG. 16b is a linking diagram between web page and DATABASE in the third embodiment of the system of the present invention with respect to FIG. 16.

FIG. 17 is a flowchart illustrating whole sequences of the method of the present invention.

FIG. 18 is a flowchart illustrating sequences for registering specific intellectual property supply information with respect to FIG. 17.

FIG. 19 is a flowchart illustrating sequences for registering specific intellectual property demand information with respect to FIG. 17.

FIG. 20 is a flowchart illustrating whole sequences for making contract of electronic commerce for intellectual property information with respect to FIG. 17.

FIG. 21 is a flowchart illustrating sequences for making contract document of electronic commerce for intellectual property information with respect to FIG. 20.

FIG. 22 is a flowchart illustrating sequences for filing international patent application of non-disclosed intellectual property information by the method of the fourth embodiment of the present invention.

### BEST MODES FOR CARRYING OUT THE INVENTION

The objects and characteristics of the present invention will be more easily understood with reference to the accompanying drawings and detailed description below. But while describing the invention, description concerning well-known and already disclosed technologies will be omitted or described in short. The same reference numbers are used to indicate like elements or functions in more than one figure.

[Definition of Term]

The term used specifically in this description is defined as following:

Intellectual property (hereinafter may be referred as “IP”) information (hereinafter may be referred as “Info”) comprises not only up to now protected intellectual property rights such as patent, design patent, trademark, utility model, copyrights, etc. but also any Information that will be so in future, but in this description only will be described mainly patent rights for convenience of description.

Service system (hereinafter may be referred as “service system”) means one or more networked computers (mainly server computer) constructed by owner practicing the present invention according to each embodiment A, B, C of the present invention, which in some cases includes computer devices 100-1 of cooperation companies described below.

Supplier of intellectual property Information (hereinafter may be referred as “supplier”) is one or more user using said user terminal who is enrolled in said service system as member and who registers into the storage device of said service system a specific IP supply Info including patent application data which has bee filed for patent in at least one country, to trade or to get help from others with filing patent application in other country and/or with demanding examination of it. Said one country comprises nations coalition like UN, EU, etc., and region like Africa, etc.

Consumer of intellectual property Information (hereinafter may be referred as “consumer”), who is corresponding to said supplier, is one or more user using said user terminal who is enrolled in said service system as member and who registers a specific IP demand Info in the storage device of said service system to obtain a corresponding IP supply Info registered or to be registered, and/or to give supplier help with filing patent application in other country, and/or with demanding examination of it in accordance with contract terms.

Counterpart contractor is a contractor who is designated for electronic commerce of specific intellectual property Information among potential consumers of it. In case of filing patent application, said counterpart contractor will file other's intellectual property Information as patent application in requested country for the purpose of his use or getting reward from supplier in his name or his responsibility according to contract terms.

IP supply Information (hereinafter may be referred as “supply Information”) comprises a patent application data filed in at least one country, identification Information of said IP Information and/or contract terms registered by said supplier.

IP demand Information (hereinafter may be referred as “demand Information”) is what said consumer of specific IP Information registers into the service system corresponding to specific IP supply Information.

User is one using the terminal which is connected with client/server computer communication network, can be client, consumer or supplier and comprises individual, corporation, business firm, government agency, patent representative like patent attorney or patent agent, investment and finance corporation and owner of said service system.

Member comprises individual or company whose identification Information (hereinafter may be referred as “ID”) is registered into user ID DB of the service system.

English contents DB and each language version contents DB comprises identification Information of IP Information, patent application file, asset valuation Information of it and related web pages in English or each country language registered by supplier or consumer of IP Information, which term is mainly used to indicate specific language version contents provided by specific service system or specific contents providing server.

There in this description are many terms other than above described, so its actual meaning should not be confined to its nominal meaning but be understood according to the associated function in the present invention.

[The First Embodiment of the Present Invention]

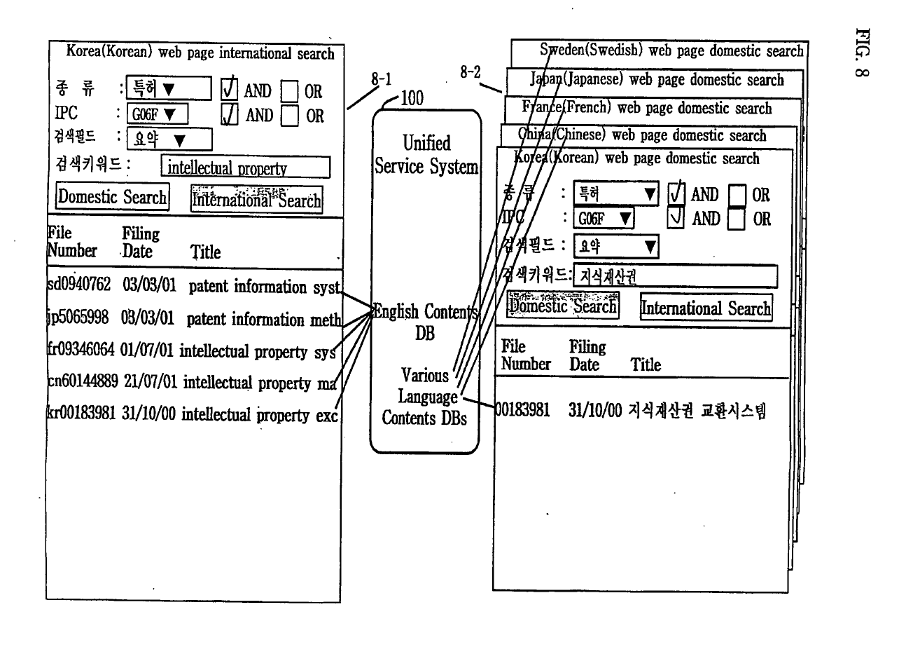

The characteristic of the first embodiment of the invention is that the whole configuration system A is mainly controlled by one service system 100 supporting various language version IP Information as illustrated in FIG. 8. Though said service system 100 operates one website for embodiment of the invention, it can support English version contents and various language version contents also. So there are illustrated user terminals 41, 42, 43 located in various countries.

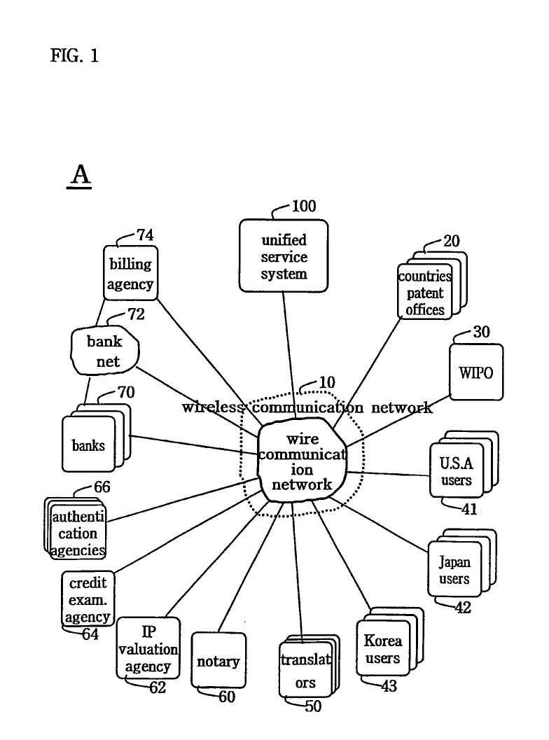

As illustrated in FIG. 1, the whole system A of the first embodiment of the present invention consists of various devices communicated with each other through wire/wireless communication network and operates. These devices comprise service system 100 mainly controlling the whole system A, various computer devices 20, 30, 50, 60, 62, 64, 66, 70, 72, 74 of cooperation companies and user terminals 41, 42, 42. As illustrated in FIG. 1, said wire/wireless communication network 10 comprises such as can construct computer communication network through wire/wireless phone network and/or wire/wireless data communication network, and further comprises gateway device (not illustrated) supporting links between wire communication network and wireless communication network if said user terminal is wireless terminal.

Said various computer devices 100-1 of cooperation companies preferably comprise:
billing server (or payment gateway) 74 linked with bank network 72 transacting fee billing job by the function of billing means 112k;
one or more bank servers 70 linked with said billing means 112k;
one or more authentication server 66 transacting digital authentication data of each user connecting to service system by the function of user authentication means 112d;
credit examination server 64 transacting credit examination data of registered users by the function of credit examination means 112i;
various country patent office servers 20 including WIPO(World Intellectual Property Organization) server 30 and IP valuation server 62 which are all related to transacting data concerning reliance and asset valuation of IP Information that has been filed in at least one country by the function of IP valuation means 112j;
notary terminal 60 transacting notary job of contract document by the function of contracting means 112h; and
translation server or translator terminal 50 transacting translating job associated with registered IP Information and/or patent application data filed in at least one country by the function of translation means 112m.

Said each computer device of cooperation companies 100-1 may be or may not be included as element of the system according to the method of performing each function of the service system, but in FIG. 1 are illustrated all computer devices of cooperation companies as an preferable exemplary embodiment of the invention.

Said user terminals 41, 42, 43 that are used by supplier and consumer of IP Information in various countries transact data for electronic commerce of IP Information transmitting over countries or for an international patent application of IP Information through communication network by the function of control module 112 of control server 110. Additional description concerning the function and operation of each element device will be described in detail referring to following figures.

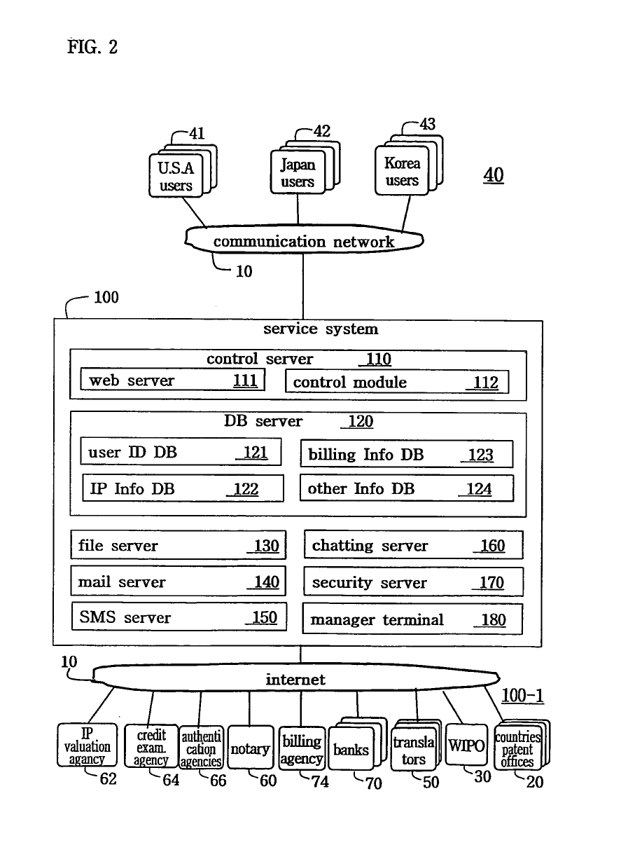

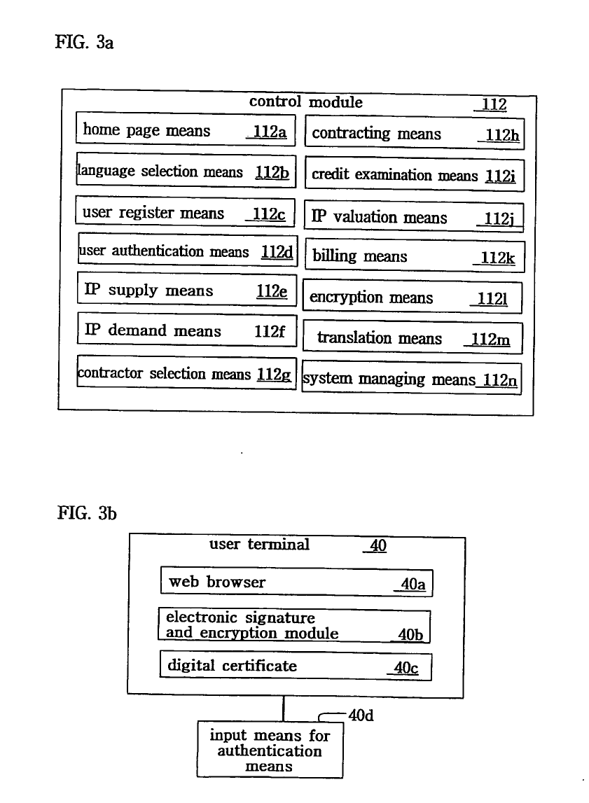

FIG. 2 is to describe the elements of service system 100 and its functions and the operation of computer devices of many cooperation companies 100-1 associated with functions illustrated in FIG. 3a. In this figure there are illustrated user terminals 40, service system 100, computer devices 100-1 of many cooperation companies, and wire/wireless communication network 10 illustrated in FIG. 1, which are all centralized in service system 100.

As illustrated in FIG. 2, said user terminals 40 exchange data with service system 100 through client/server computer communication network 10 and said service system 100 exchanges data with many computer devices 100-1 of cooperation companies through Internet 10.

Said user terminals have wire/wireless communication function, are located in various countries and exchange data with other devices through wire/wireless communication network by the function of said service system and/or can retrieve Information of service system and communicate with service system data used for operation of service system. Which includes not only computer but such as can be used like computer, for example, wireless terminals such as PCS phone, cellular phone, PDA, smart phone, IMT-200, etc., Internet TV, Internet set-top box, etc.

Preferably said terminal comprises as illustrated in FIG. 3 at least web browser 40a, electronic signature and encryption module 40b for electronic signature and encrypting and decrypting secrete data, digital certificate 40c identifying user with electronic means and input device 40d for authentication means. Said input device for authentication means 40d comprises keyboard, bio-authentication means, voice authentication means, and other authentication means using various computer-readable storage medium, etc., through which user terminal can authenticate user's identity. Said storage medium comprises compact disk, IC (integrated circuit) card, flash memory, etc. which can contain authentication Information as well as billing Information. In which case said user terminal may comprise further billing module.

Said electronic signature and encryption module 40b is means for digital signing on digital document and encrypting non-disclosed IP Information and is linked to encryption means 1121 of control module 112 described below, which is downloaded and installed in specific section of storage device of user terminal when user registers into said service system as member or which is imbedded into user terminal in production stage by a user terminal manufacture company.

Said digital certificate 40c is electronic pubic-certificate issued through authentication agencies 66 and is means used for identifying user ID automatically and for electronic signature and encryption of digital document by electronic signature and encryption module 40b, which can be installed in the storage device of user terminal or in potable computer-readable storage medium like IC card used for said input means 40d as illustrated in FIG. 3b.

Said computer devices 100-1 of cooperation companies as described above consist of various country patent offices 20, WIPO 30, translators 50, banks 70, billing agency 74, notary 60, authentication agencies 66, credit examination agency 64, IP valuation agency 62, and communicate for operation of the invention with said service system 100 through Internet 10 and/or private communication line, and are commonly equipped with OS (Operating System) and communication means like communication device and protocol, etc., and additionally one or more application programs such as web server, merchant server, mail server and/or DBMS server, etc. in accordance each use and function. Which are well known to the expert in the art, so the detailed description concerning said computer devices is omitted below.

In this figure there are illustrated said service system 100 consisted of various computer devices comprising control server 100, SMS (Simple Message Service) sever 150, chatting server 160, security server 170, manager terminal 180, connected with each other through intranet and/or Internet but the functions of all said computer devices except manager terminal 180 can be performed through one server or through more function servers separated specifically in accordance with specific functions of control module 112 as in FIG. 3a, which is also well known to the expert in the art, so the detailed description concerning it is omitted below.

Said control server 110 consisted of web server program 121 and control module 112 functions as gateway for said service system and controls the whole system of the present invention. User interface for execution of the invention in each embodiment can be GUI (Graphic User Interface)-based display through web server program 121 or text-based display, which is well known to the expert in the art.

Said DB server 120 is device for storing data generated in the process of operation of the invention and/or registered by manager of said service system in the form of Database, said Database can be one unified form or various forms separated according to specific functions or languages used for the contents, but in the Figures of this description are illustrated to be built according to functions such as use ID DB 121, IP Info DB 122, billing Info DB 123 and other Info DB 124 to be corresponding to each element of control model 110 illustrated in FIG. 3a. Though not illustrated in Figures of this description, it is desirable that each functional DB comprises various tables, index files and contents files linked with these, and said each functional DB is built and managed by related functional module of control module as illustrated in FIG. 3a, and though not illustrated in Figures of this description, it is also desirable for said each DB to be built according to language used for each home page provided by said service system.

Said user ID DB 121 consists of various information comprising user identification information (e.g., user ID, password and name), registered date, phone number, nationality, email, address, language use code, billing information, digital certificate information and credit examination information.

Said IP Info DB 122 consists of various information required for international electronic commerce of IP information, for example, IP supply information filed at least one country and registered by supplier including its identification information, contract terms for electronic commerce and translated version of these, IP demand information registered by supplier corresponding to IP supply information including its identification information, contract terms and translated version of these, contract terms determined between contractors and/or contract document file.

Said billing Info DB 123 consists of fee related information generated in the process of registering IP information into said service system and/or trading, including various information such as fee charge number, fee title, user ID, fee charged, paid fee amount, fee paid date, deposit account, ect.

Said other Info DB 124 preferably consists of various information related to operation of said service system such as various electronic board data, question/answer data, fee table based on each service, information related to guiding user through service system, etc.

Said user ID DB, IP Info DB, and billing Info DB are preferably linked with each other based on IP identification information.

Said file server 130 is storage means of various files linked to said control server and/or said DB server, said mail server 140 and said SMS server 150 are means for various messages transmitted between said service system and members or between members, said chatting server 160 is chatting means for negotiating between potential supplier and potential consumer, said security server 170 is means for protecting said service system from attach of hackers, viruses, etc., said manager terminal is means for administering and operating said system by administrator of said system.

In this figure, only one server for each above server respectively is illustrated, but in actual practice of the invention said each server may includes more servers according to necessity, which is well known to the expert in the art.

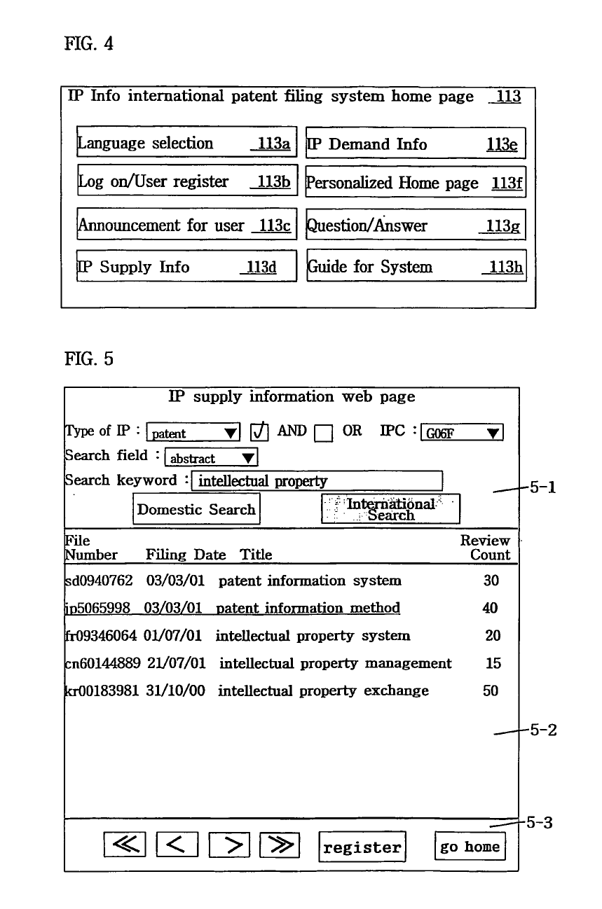

FIG. 3a is a detailed block diagram of said control module 112, and FIG. 4 is an exemplary initial home page which is one of elements of said control module 112 of said service system corresponding to home page means 112a of FIG. 3a.

Each element module described below is a functional element (component or means) of said control module 112 of the present invention and is mainly claimed as “step” or “module” in embodiment of method or program of the invention respectively, and as “module”, “means” or “unit” in embodiment of system of the invention in the appended claims.

Said control module 112 is computer program practicing the method of the present invention contained in said storage device (not illustrated) associated with said control server 110 and executed by CPU (Central Processing Unit, not illustrated) of control server 110, through which said CPU executes the method of the present invention by controlling each constituent element (component) devices such as various server computer devices 130, 140, 150, 160, 170 of said service system including DB server 120, said cooperation company computer devices 100-1 and user terminals 40, etc., also said computer program can include data storage module such as database linked with said program and web page, etc.

Said storage device is computer-readable storage medium such as ROM, RAM, Magnetic tape, floppy disk, optical data storage device and means implemented in the form of carrier waves (for example, transmitted via Internet), etc., also may be distributed, stored and executed in several computer systems which are connected with each other via communication network in computer-readable codes

Hereinafter with reference to various figures, the function and operation of the present invention is described in detail as centralized in control module 112.

Said control module includes home page means 112a, language selection means 112b, user register means 112c, user authentication means 112d, IP supply means 112e, IP demand means 112f, contractor selection means 112g, contracting means 112h, credit examination means 112i, IP valuation means 112j, billing means 112k, encryption means 112l, translation means 112m and system managing means 112n.

Said control module is operated to execute the invention in accordance with control signals of user received via communication network and is assumed to be encoded in Hyper Text (Link) Language such as XML and/or HTML, etc. combined with script language such as Java script, Visual Basic script, ASP (Active Server Page), PHP, Perl, etc. and is implemented in web/DB linking way, however, can be encoded in other various languages according to operating environment of the servers and user terminals and the progress state in programming art.

Preferably said computer program and contents provided by said service system 100 can be used by wireless user terminals as converting them into other format suitable for wireless communication through gateway device (not illustrated).

Said home page means 112a is user interface means linked with relevant elements of said control module 112 including initial home page which is provided as soon as user connect with said service system first. As illustrated in FIG. 4, said initial home page preferably consists of many components comprising various selection means (menu or icons) linking to corresponding element(s) of said control module 112, such menus as Language selection 113a, Logon/User register 113b, Announcement for user 113c, IP supply Info 113d, IP demand Info 113e, Personalized home page 113f, Question/Answer 113g, Guide for system 113h, etc.

Said Language selection means 112b is to move workspace of the CPU from specific version language contents storage section (space) to other language version contents storage (space). When user connects with said service system, the language used for contents of said service system is one predetermined by said service system 100 but user can change the default language into other language desired manually through language selection menu 113 displayed in said initial home page or the language is automatically changed into one desired by user in initial access stage through the operation of language selection means 112b in one of the following ways:
1) When user logs on to specific language version home page, control server verifies user default language use information stored in user ID DB 121 and determines whether to switch the language of home page or not based on log-on information;
2) When user first registers user ID and/or logs onto service system, control server 110 stores user attribute information including ID in specific storage section in the form of cookie file, ect., and when user connects with web-site of said service system again, control server verifies user default language use information stored in user ID DB 121 based on user ID of said attribute information without log-on process and determines whether to switch the language of home page or not based on said verified language use information;
3) In 2) when control server 100 stores user attribute information in cookie file, ect., user default language use information is also included in the form of classification code like English as “1” and French as “2”, and when user connects site-site of said service system again, control server directly verifies user default language use information based on said classification code in said cookie file without log-on process and reference to user ID DB 121. Said language classification code can be international standard code if there it is.

Said user register means 112c and user authentication means 112d are linked to User register menu and Log on menu (icons) respectively:

Said user authentication means 112c verifies whether user ID is registered in user ID DB 121 as soon as user connects with web site and does log-on process;
Said user register means 112d preferably comprises;
the function of registering user ID in use ID DB 121 if he/she is verified as not registered through user authentication means 112d, or before/without log-on process in accordance with user's free choice using User register menu (icon) as in FIG. 4;
the function for registered user to download said electronic signature and encryption module 40b from said service system 100 and to install in user's terminal in plug-in way, the function of reviewing and editing registered user information, and/or the function of newly issuing digital certificate 40c, if needed, through said authentication agencies 66, and additionally of verifying the validity of term, ect. of the digital certificate issued from other site, or by other authentication agencies and registering it into user ID DB 121 if it is possible.

Said user identification information can be verified in other way such as automatically retrieving user ID from specific storage section of user terminal and/or from removable storage medium such as IC card containing user ID and/or digital certificate through input means for authentication means 40d.

And after registering user ID, it is preferable to examine credit rate regarding said registered user, and register the resulting information into user ID DB and provide to other users on demand while trading or contracting between members, wherein said examined credit rate can be preferably adjusted according to the points resulting from user's utilization of said service system.

Said IP supply means 112e operates as following steps:
1) electronically receives the supply information of IP Info including bibliographic information thereof, filed application file and/or application file's URL from said user terminal; said language used for bibliographic Info and filed application of said IP supply Info and for said contract comprises one or more among filed language and English. Said bibliographic Info and filed application of registered IP supply Info are translated in English version through translation means 112m if these are not English version.
2) asset value of said registered IP Info is valuated through IP valuation means 112j and valuated Info thereof is registered.
3) said registered IP Info is sent to user through various communication means such as web page for IP supply Info as in PIG. 5, mail, personalized web page for each registered user as in PIG 12. Said mail type is preferably like personalized web page for each registered user as in PIG 12.

Said translation into English version is preferably carried out mainly by translation server or outside translators 50, but also may be carried out by translators of said service system itself or using various well known translation computer programs.

Said IP asset valuation may be carried out by service system at first-hand, said IP valuation agencies 62, predetermined expert or a well known asset valuation computer program like one cited above as prior art after referring to related patent office about accuracy of filed application. Said IP asset valuation by said service system comprises a way like analyzing user opinion about registered IP Info written in a bulletin web-board and/or analyzing user retrieval counting of it.

Said translation version Info, IP valuation Info and IP demand Info described below are preferably stored into IP Info DB 122 to be linked with each other.

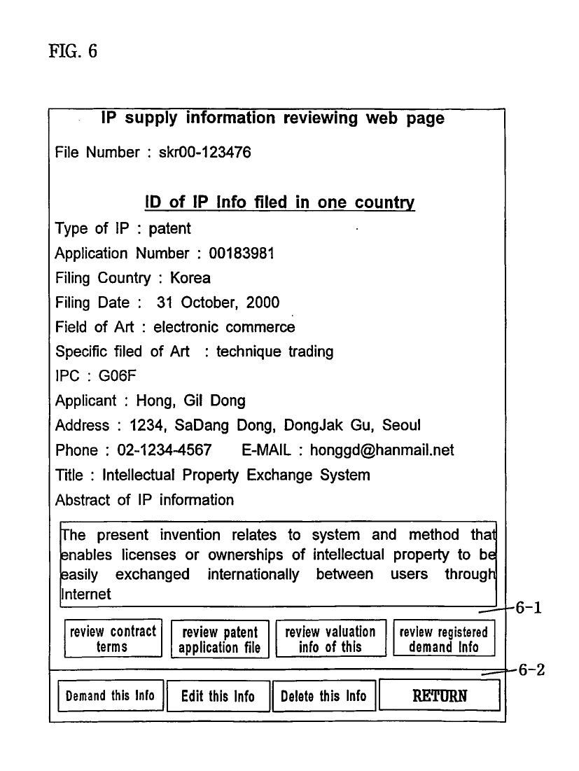

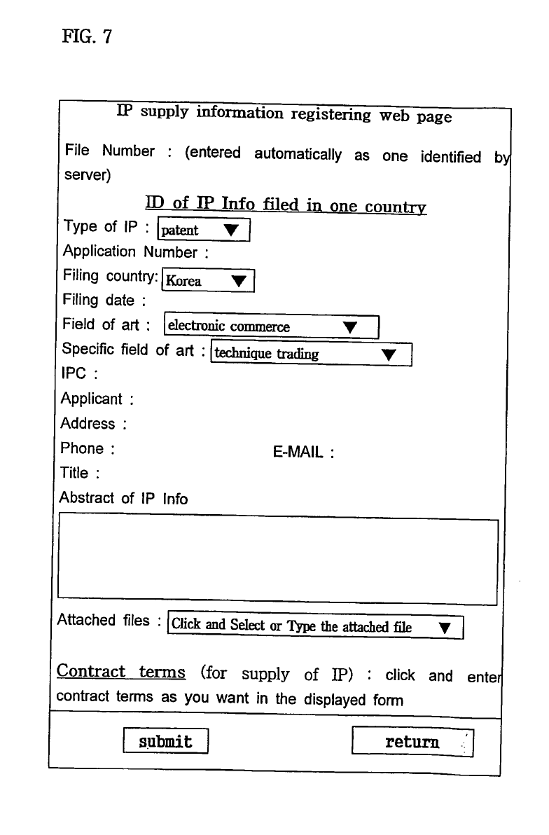

FIG. 5 is an exemplary web page for illustrating a function of said IP supply means 112e which is linked with IP supply Info menu 113d in FIG. 4 and consists of searching section 5-1 for inputting (selecting) searching condition (e.g., Type of IP, IPC code, search field, search keyword, etc.), displaying section 5-2 for providing searched index Info of bibliographic Info of IP supply Info and menu section 5-3 including several menus. When user selects (clicks) specific index Info line functioning as dynamic menu displayed on in section 5-2 with pointing means like mouse, then underlying IP supply Info is supplied through reviewing means like FIG. 6 where user can also edit and delete this Info if he/she is owner of this Info. And IP supplier selects “register” menu in menu section 5-3 and can register new IP supply Info through registering means like FIG. 7. There in searching section 5-1 are menus as “domestic search”, “international search” for confining search scope. If user selects “domestic search”, IP supply Info in language selected through language selection means 112b are retrieved from IP Info DB 122, whereas if user selects “international search”, only English version IP supply Info are retrieved from IP Info DB 122. Wherein the language used for keyword search of “international search” should be English, but can be other languages in case language translating program into English is automatically operating based on keyword searching engine computer program. There in said displaying section 5-2 are illustrated all English version index Info (consists of “File Number, Filing Date, Title) of bibliographic Info and review count which can be used as data for IP asset valuation by IP valuation means 112j in accordance with search condition and search scope.

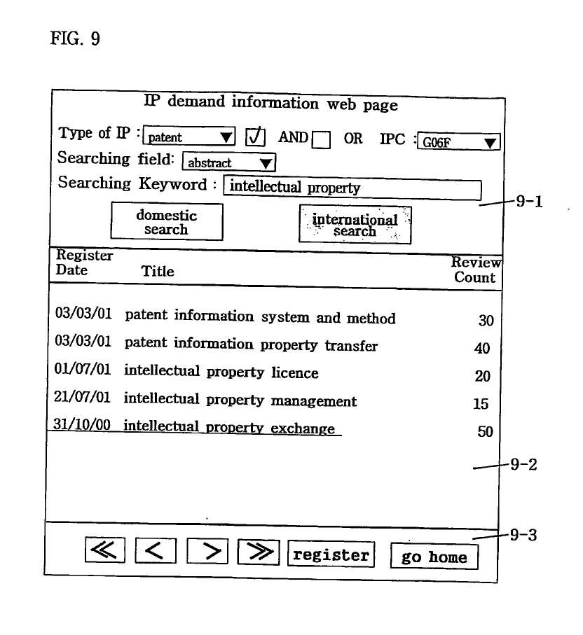

FIG. 6 is an exemplary reviewing web page for registered specific IP supply Info, illustrating a reviewing function of said IP supply means 112e, which is provided by selecting (clicking) index Info line of bibliographic Info of specific IP supply Info in displaying section 5-2 of FIG. 5, and consists of displaying section 6-1 and menu section 6-2. There in displaying section 6-1 are illustrated bibliographic Info of specific IP supply Info including “File number” functioning as ID and various menus functioning as linking means such as “review contract term”, “review patent application file” which link to contract terms for filing application in other countries and all contexts of filed application respectively, “review valuation Info” which links to asset valuation Info of this IP and “review registered demand Info” which links to search means for IP demand Info corresponding to this IP supply Info like searching web page as in FIG. 9. Preferably said “review registered demand Info” menu is accessed by owner of this IP supply Info. Said menu section 6-2 includes:

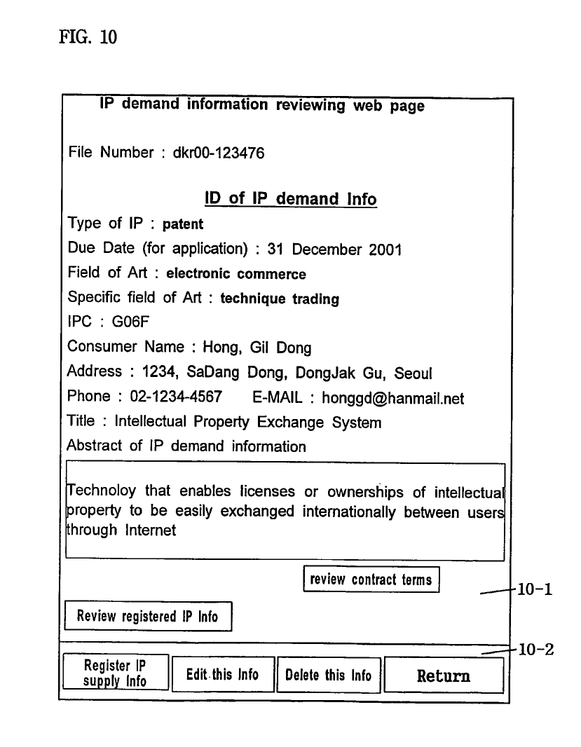

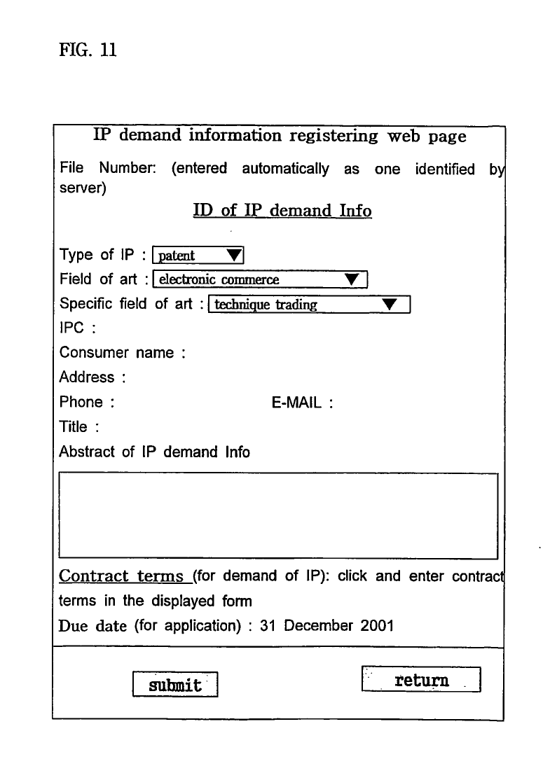

“Demand this Info” menu which links to a data input function of said IP demand means 112f, which can be implemented with similar technique used in FIG. 11, for IP demand Info to file patent application of IP supply Info displayed in displaying section 6-1, related with above “review registered demand Info” menu in section 6-1, whereby registered IP demand Info is preferably used for the context of “IP consumer's ID and contract terms” 13-2 in lower section of FIG. 13 and is provided to users through as FIG. 9, or FIG. 10, etc.; and

“Edit this Info” and “Delete this Info” menus which link to edit and delete function of said IP supply means 112e as described above and are preferably accessed only by owner of this IP supply Info.

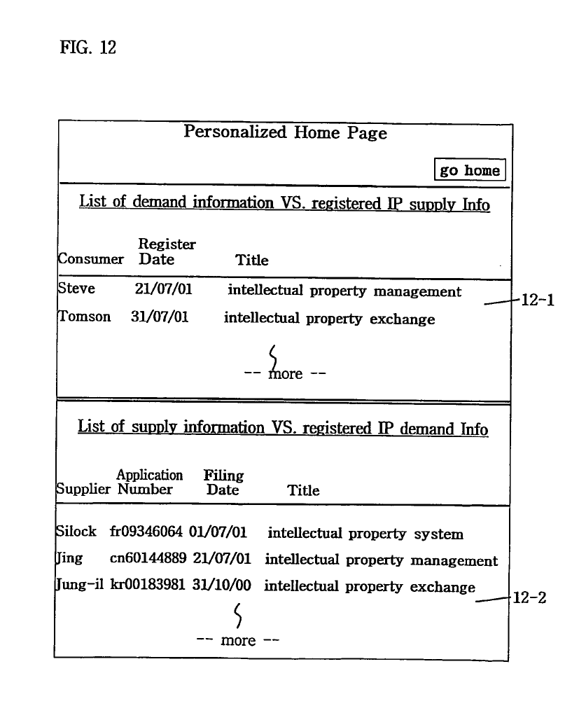

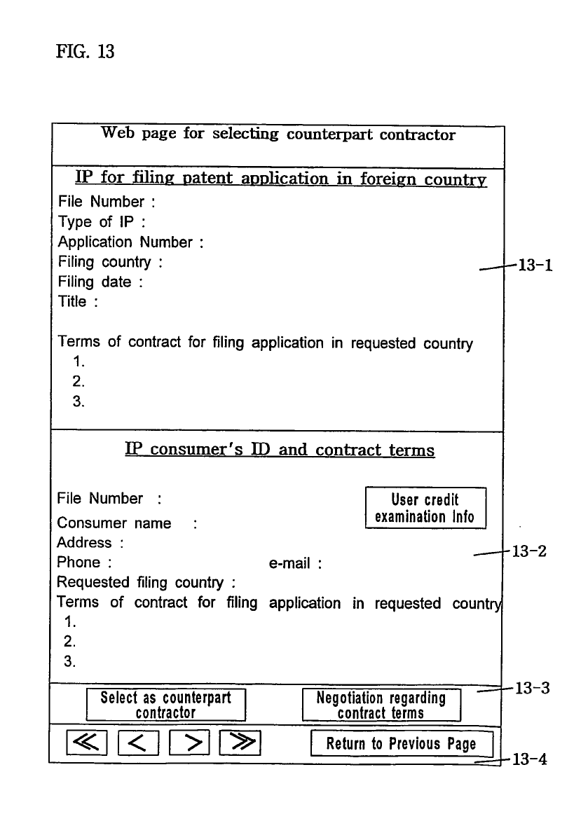

FIG. 7 is an exemplary registering means (web page) for specific IP supply Info linked with FIG. 5. The IP supply Info registered through FIG. 7 comprises bibliographic Info, contract terms, filed application file and/or application file's URL. At this time user should pay registering fee using said billing means 112k if that is required. After finishing above all processes, said service system translates registered IP supply Info into English version (if needed), valuates it, stores them to be linked with each other in IP Info DB 122 and provides to users using Info providing means such as mail and/or various web pages like FIG. 5, FIG. 6 and FIG. 10, FIG. 12.

FIG. 8 is for illustrating the exemplary methods of linking data between web pages and database and of establishing various language version web sites based on one unified service system which is a feature of first embodiment of the present invention, and is an simplified exemplary searching web page of FIG. 5 in specific language (e.g., Korean) version selected through language selection means 112b.

Numeral 8-1 is an exemplary web page for illustrating “international search” function in an Korean version IP supply Info searching web page of first embodiment, wherein when user defines each searching option by clicking with a mouse, for example, [symbol] (patent) as [symbol] (Type of IP), G06F as IPC, [symbol] (abstract) as [symbol] (Search Field) and types “intellectual property” in English as [symbol] (search keyword) and selects (clicks) “international search” menu, accordingly is retrieved and provided all English version IP supply Info registered by various country (language) users corresponding to search condition from English version contents DB of IP Info DB 122 as described above with respect to FIG. 5.

Whereas, numeral 8-2 is an exemplary web page for illustrating “domestic search” function in various language version (including Korean version) IP supply Info searching web pages of first embodiment, wherein when user defines each searching option by clicking with a mouse, for example, [symbol] (patent) as [symbol] (Type of IP), G06F as IPC, [symbol] (abstract) as [symbol] (Search Field) and types [symbol] in Korean (requested language) as search keyword and selects (clicks) “domestic search” menu, accordingly is retrieved and provided only Korean (requested language) version IP supply Info registered by Korean (corresponding country or language) users corresponding to search condition from Korean (requested language) version contents DB of IP Info DB 122.

FIG. 8 shows that unified service system 100 provides only 5 language version home pages, but in actual stage it can provide more language versions necessary according to policy of service system wherein each language version contents meta DB can be built separately apart from each other or be built in type of each language table of one IP Info DB 122.

The problem of first embodiment is that said one unified service system has to build various language version web sites alone including IP Info DBs 122 linked therewith.

FIG. 8 only illustrates the method of linking IP Info DB 122 to home page with respect to IP supply Info case referring to FIG. 5 but it is justly applied to IP demand Info case referring to FIG. 9.

Said IP demand means 112f operates as following steps:
1) electronically receives IP demand Info from said user terminal; said language used for IP demand Info comprise one or more including English. Said registered IP demand Info is translated in English version through translation means 112m if this is not English version.

2) Said registered IP demand Info is sent to user through various communication means such as web page for IP demand Info as in PIG. 9, mail, personalized web page for each registered user as in PIG 12. Said mail type is preferably like personalized web page for each registered user as in PIG 12.

Said IP demand Info comprises contract terms corresponding to said registered specific IP supply Info or the contract terms including the ID of IP supply Info and/or the reward information for the specific IP supply Info not registered yet in said service system to be provided based on buyer initiative auction,

FIG. 9 is an exemplary web page for illustrating a function of said IP demand means 112f which is linked with IP demand Info menu 113e in FIG. 4 and consists of searching section 9-1 for inputting (selecting) searching condition (e.g., IPC number, field, keyword, etc.), displaying section 9-2 for providing searched index Info of bibliographic Info of IP demand Info and menu section 9-3 including several menus. When user selects (clicks) specific index Info line functioning as dynamic menu displayed on in section 9-2 with pointing means like mouse, then underlying IP demand Info is supplied through reviewing means like FIG. 10 where user can also edit and delete this Info if he/she is owner of this Info. And IP consumer selects “register” menu in menu section 9-3 and can register new IP demand Info through registering means like FIG. 11. There in searching section 9-1 are menus as “domestic search”, “international search” for confining search scope. If user selects “domestic search”, IP demand Info in language selected through language selection means 112b are retrieved from IP Info DB 122, whereas if user selects “international search”, English version IP demand Info are retrieved from IP Info DB 122. Wherein the language used for keyword search of “international search” should be English, but can be other languages in case language translating program into English is automatically operating based on keyword searching engine computer program. There in said displaying section 9-2 of this figure are illustrated all English version index Info of bibliographic Info of IP demand Info corresponding to search condition in accordance with user's selection of “international search” option.

FIG. 10 is an exemplary reviewing web page for registered specific IP demand Info, illustrating a reviewing function of said IP demand means 112f, which is provided by selecting (clicking) index Info line of bibliographic Info of specific IP demand Info in displaying section 9-2 of FIG. 9, and consists of displaying section 10-1 and menu section 10-2. There in displaying section 10-1 are illustrated bibliographic Info of specific IP demand Info (including “File number” functioning as ID) and menus functioning as linking means such as “review contract term” linked to contract terms of said bibliographic Info and “review registered IP Info” linked to registered IP supply Info corresponding to this IP demand Info through searching web page as in FIG. 5. Preferably said “review registered IP Info” menu is accessed by owner of this IP demand Info. Said menu section 10-2 includes:

“Register IP supply Info” menu which links to a data input function of said IP supply means 112e, which can be implemented with similar technique used in FIG. 7, for registering IP supply Info corresponding to IP demand Info displayed in displaying section 10-1 of FIG. 10, related with above “review registered IP Info” menu in section 10-1, whereby registered IP supply Info is preferably used for the context of “IP for filing patent application in foreign language” 13-1 in upper section of FIG. 13 and is provided to users through as FIG. 5, or FIG. 6, etc.;
“Edit this Info” and “Delete this Info” menus link to edit and delete function of said IP demand means 112f and are preferably accessed only by owner of this IP demand Info.

FIG. 11 is an exemplary registering means (web page) for specific IP demand Info linked with FIG. 9. Said service system registers through FIG. 11 the IP demand Info which comprises bibliographic Info and contract terms and translates into English version, if needed (e.g., it is not English version), stores them to be linked with each other in IP Info DB 122 and provides to users using Info providing means such as mail and/or various web pages like FIG. 6, FIG. 9, FIG. 10 and FIG. 12.

FIG. 12 is an exemplary web page personalized for each registered user and linked with personalized home page menu 113f of FIG. 4, operating as following:
when user registers information corresponding to IP supply and/or demand Info, said service system automatically generates personalized web page as FIG. 12 linked with all related registered IP supply and/or demand Info and provides to users;
for registered IP supply Info, user clicks one of demand Info index line as dynamic linking means (menu) displayed in upper section 12-1 of this web page so that detailed bibliographic Info of IP demand Info may be provided through Info providing means as FIG. 10;
whereas, for registered IP demand Info, user clicks one of supply Info index line as dynamic linking means (menu) displayed in lower section 12-2 of this web page so that detailed bibliographic Info of IP supply Info may be provided through Info providing means as FIG. 6.

FIG. 12 can be used initial home page provided after log-on process at the web site associated with the present invention, and further comprises selection means (menus) for registering and editing user Info linked to user register means 112c.

Said contractor selection means 112g is a functional module for selecting counterpart contractor among consumers who want to file patent application for specific IP supply Info in requested foreign countries, wherein the method of selecting counterpart contractor is one of the following:
an auction method in which supplier of specific IP Info selects counterpart contractor among appropriate consumers and sends the selected information to said service system through said user terminal after receiving and referring the registered contract terms with respect to that IP supply Info and/or consumer's profile information and credit examination information;
a consumer initiative auction method in which consumer of specific IP Info selects counterpart contractor among appropriate suppliers and sends the selected information to said service system through said user terminal after receiving and referring the registered contract terms with respect to that IP demand Info and/or supplier's profile and credit examination information;
an automation method in which said service system 100 automatically selects contractors by a computer program module based on the contract terms with respect to registered specific IP supply or demand Info, referring each one's profile and credit examination Information if needed.

FIG. 13 is an exemplary web page for selecting counterpart contractor in an auction method by contractor selection means 112g, which web page can be accessed through “review registered demand Info” menu of FIG. 6. Whereas selecting counterpart contractor in a consumer initiative auction (reverse auction) method also can be embodied referring the technique used for said auction method, which web page can be also accessed through “review registered IP Info” menu of FIG. 10. FIG. 13 consists of “IP for filing patent application in foreign country” section 13-1, “IP consumer's ID and contract terms” section 13-2 and menu section 13-3, 13-4, so that user can review required information and select counterpart contractor conveniently in one interface display.

Wherein section 13-1 includes bibliographic information of specific IP Info filed in at least one country and contract terms including reward information promised to reward counterpart for filing application;
section 13-2 includes user ID who wants to file in requested country, contract terms and user credit examination Info, preferably more includes planning for commercializing this IP and information relevant to his/her capability of driving business;
section 13-3 includes “select as counterpart contractor” menu which links to contracting means 112h supporting making contract with counterpart contractor for filing application, “negotiation regarding contract terms” menu which links to means for negotiation with potential counterpart contractor regarding contract terms through communication means such as chatting server 160, SMS server 150, IM (Instant Messenger) server and/or email, wherein information relevant to selecting counterpart contractor and/or negotiation is sent to said service system, stored IP Info DB 122 and used for data of making contract document;
menus of section 134 are means for helping user to easily move reviewing pointer forwards or backwards if search engine has searched many requested data.

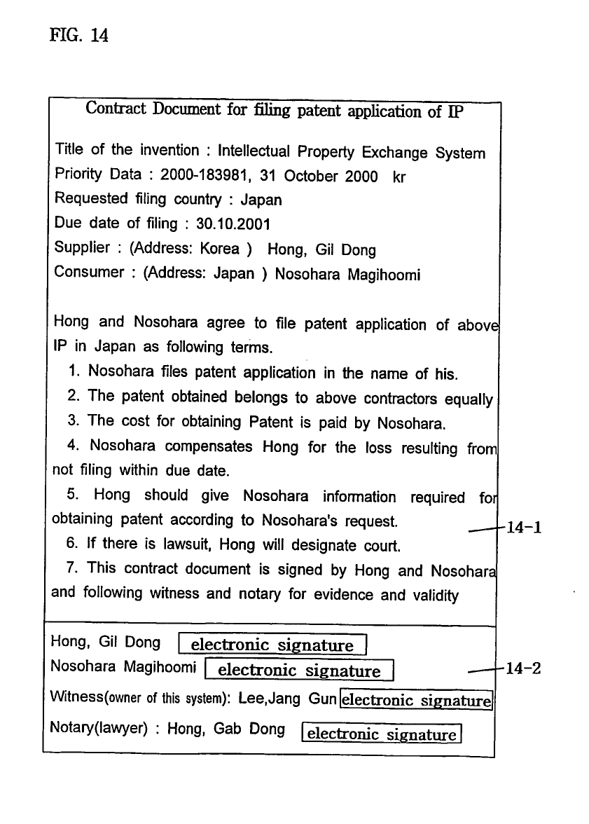

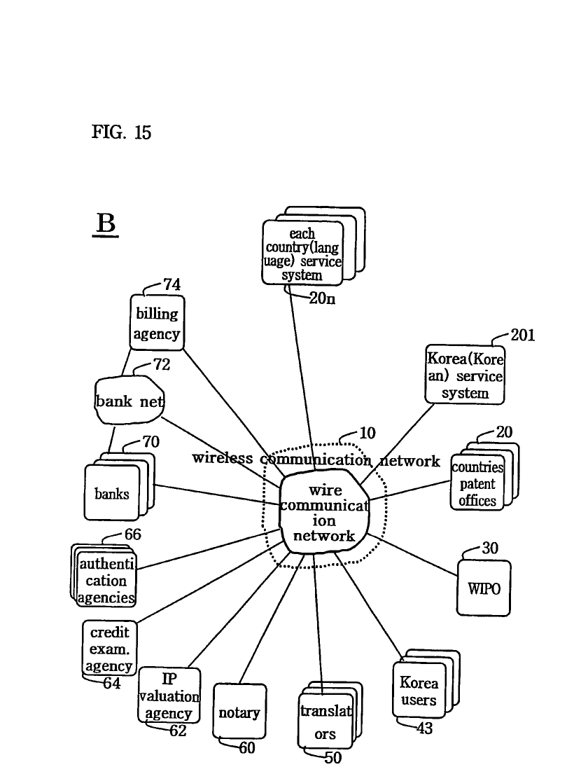

Said contracting means 112h is a functional module for supporting making contract document for filing application of specific IP Info between contractors by controlling said control server 100 and is consisted of:
web/Db linking module which generates contract document display file for filing application as FIG. 14 by dynamically linking a requested contract document form page of various kinds of standard contract document template form web pages prepared and classified in accordance with IP type (e.g., patent, utility model, design patent, trademark, etc.) and/or purpose of contract (e.g., trade, exchange, license, payment of filing fee, etc.), bibliographic Info of IP and contract terms predetermined between contractors;
contract document transmission module for transmitting said generated contract document display file to each contractors and receiving signed contract document file from each contractors; and
electronic signature module controlling digital signing on said digital contract document by contractors and/or third parties like notary, etc.
more specifically the process of said contracting means 112h comprises the following steps of:
1) said control server transmitting to each contractor in predetermined sequence through said terminals one digital contract document display file for filing patent application as FIG. 14 generated by said web/DB linking module;
2) said each contractor reviewing said contract document file, placing electronic signature on it and transmitting to said control server; and
3) said control server storing said contract document file into IP Info DB 122 as a confirmed contract document file for filing application of IP Info.

Wherein the type of said electronic signature data placed on contract document file comprises bar code, watermarking, digitalized seal data and/or digitalized handwritten signature data, etc. and preferably digital certificate for placing electronic signature is authenticated internationally.

And preferably said contracting process further comprises the step of control server merging electronic signatures accepted from the predetermined notary 60 and/or witness like owner of said service system onto said confirmed contract document file.

And preferably said contracting process further comprises the step of control server transmitting to each contractor said confirmed contract document file through said user terminals to be stored into said user terminal and/or printed through printer connected thereto. Moreover said contract document can be signed in a way how it is printed on papers, transmitted to user via postal service and to receive handwritten signature from contractors.

FIG. 14 is an exemplary web page of contract document for filing patent application of IP Info. Which consists of “ID of IP for filing patent application in at least one country” section 14-1 and signing section 14-2, wherein contract terms comprises requested filing country, distribute rights of issued patents, payment of filing fee, compensation for loss from filing late and/or court at lawsuit, etc.

But contract terms can be actually determined through negotiation between counterparts, so can includes more or less terms than these, therefore the present invention should not be confined to applying only to a patent case although this description is mainly described based on patent case in consideration of clear description and easily understanding but should be understood to be able to apply to all kinds of contract cases available such as trade, exchange, license and further like payment of examination fee for patent application if the applicant has not demanded examination of it in some countries which have a patent institution capable of this. For which cases the contract document form as FIG. 14 should be modified properly in accordance with usages like trade, exchange and license, etc. Therefore it is natural that appended claims are applied not only to obtaining IP rights case like patent, utility model, design patent, trademark and copyright but every kind of dealing case available like trade, exchange, license and payment of examination fee, etc.

Said reward is done mainly by supplier of IP Info to consumer as counterpart contractor for helping filing patent application anyway but in case of transferring all or part of patent ownership and denomination of ownership, etc., can be done by said consumer to said supplier.

Said credit examination means 112i of FIG. 3a is a functional module for examining registered user's credit rate through said credit examination agency 64 and/or by service system directly through predefined rules of service system, wherein said examined credit rate can be preferably adjusted according to the points resulting from user's utilization of said service system.

Said IP valuation means 112j of FIG. 3a is a functional module for valuating the asset value of registered IP Info by said IP valuation agencies 62, predetermined expert and/or by service system at first-hand referring disclosed patent application Info DB of related patent offices 20, 30. Which can be also done by a known asset valuation computer program or by a way like analyzing user opinion about registered IP Info written in a bulletin web-board and/or analyzing user retrieval counting of it.

Said billing means 112k of FIG. 3a is a functional module for charging for/receiving the service fee predetermined by said service system based on each service. The amount of said service fee can be determined in accordance with service type such as registering IP Info, contracting, translation, IP asset valuation, etc. Time of fee charge can be when IP Info is registered and/or contract is made. The way of billing of said service fee comprises payment to bank account via online, by credit card and electronic money, etc. and preferably the billing information is encrypted through said encryption module and transmitted in encryption format when fee is paid through communication network.

Said encryption means 1121 of FIG. 3a is a functional module for encrypting and/or decrypting billing information and/or non-disclosed IP Info, etc. and sending and/or receiving it. For which said user terminal is installed with electronic signature and encryption module 40b, digital certificate 40c and input means for authentication means 40d as described above and illustrated in FIG. 3b. However encryption technologies required for embodiment of the present invention is well known to those skilled in the art, which includes Public Key Infrastructure like RSA encryption algorithm and ECC (Elliptic Curve Cryptosystem), therefore will not be described in detail.

Said system managing means 112n of FIG. 3a is a functional module associated with Announcement for user 13c, Question/Answer 113g and Guide for system 113h, etc. of FIG. 4 and has functions required for providing to and/or receiving from users the information based on user's demand, and/or for managing said service system, which links to other Info DB 126.

[The Second Embodiment of the Present Invention]

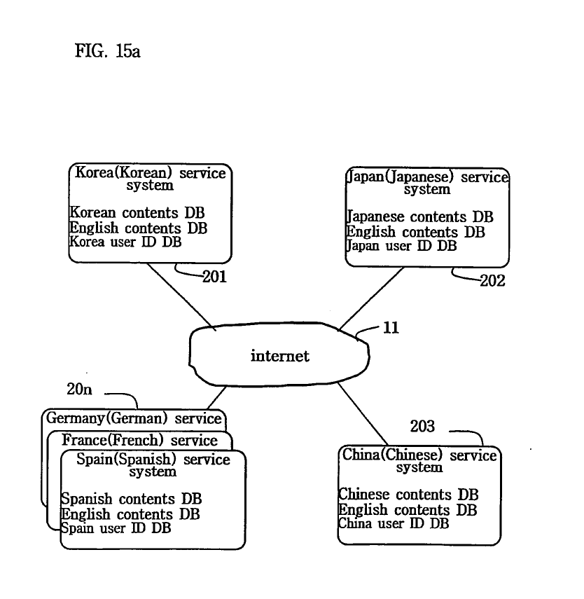

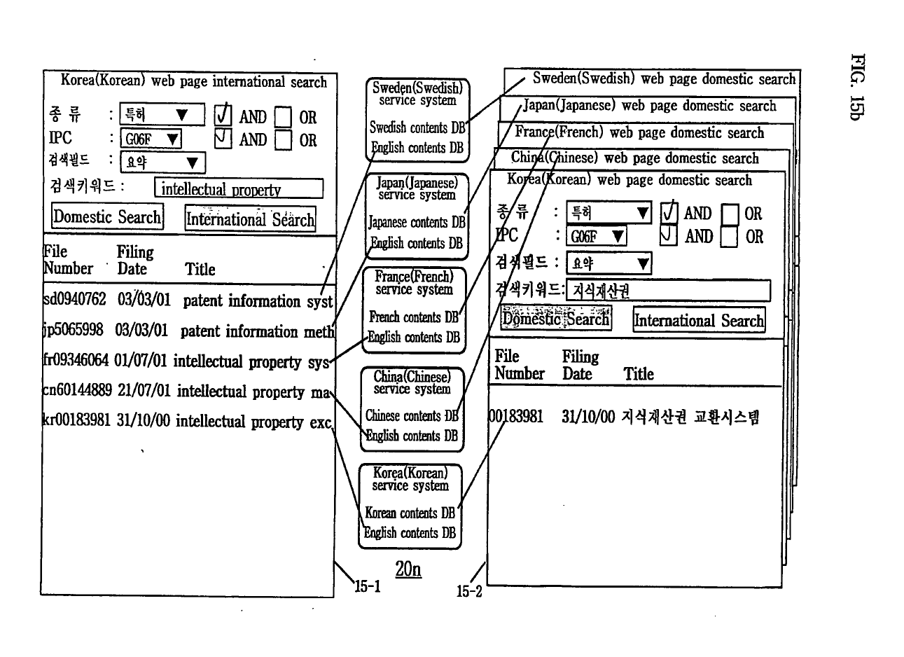

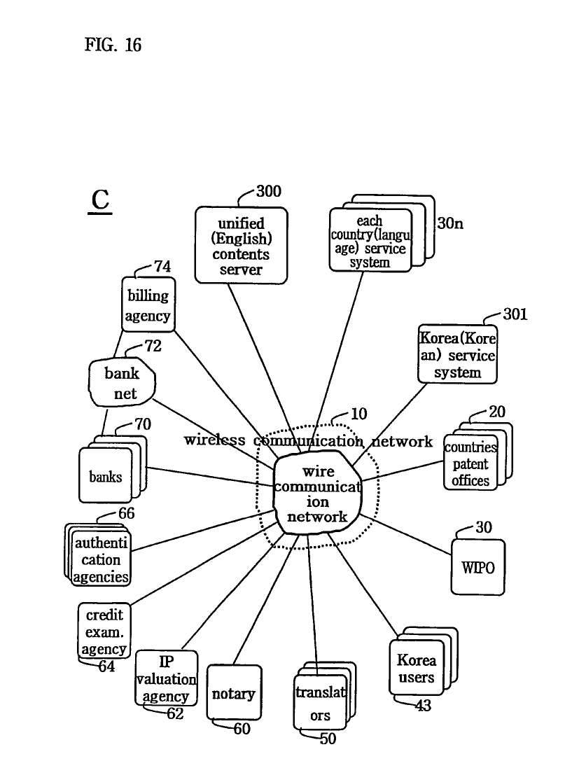

FIG. 15 a block diagram of the second embodiment of the system B of the present invention.

This embodiment differs from the first embodiment in that many of said service system 100 described above are established in accordance with each country or language separately and respectively worldwide in the form of country (or language) service systems 20n, 201, 202, 203 as illustrated in 15a. The specific feature of which is that each country (or language version) service system builds and manages its own mother language version contents DB and corresponding English contents DB and additionally user ID DB in accordance with each language or country, whereas in first embodiment, only one service system build various language contents DB and corresponding English version contents DB to serve worldwide. Therefore hereinafter the feature of the second embodiment is mainly described focused on the difference aspect from the first embodiment.

There in this figure is illustrated a configuration block diagram of the system of the second embodiment, which further comprises many country (or language version) service systems 20n including Korea (or Korean) service system 201 without oversea users 41, 42 in FIG. 1 in comparison with that of the first embodiment in FIG. 1, because said configuration is customized for Korea (or Korean) business case, so all illustrated computer devices except various country patent offices 20 and WIPO 30 are mainly for Korea (or Korean) business case, as is the same with other country (or language) business cases though not illustrated in figures.

FIG. 15a is a diagram illustrating data linking between many service systems 20n classified by country or language with respect to the second embodiment of the invention.

As described above, each illustrated country (or language version) service system 201, 202, 203, 20n operates each corresponding language version web site (home page) and also through which builds and serves to users its own mother language version IP contents DB and corresponding English IP contents DB and additionally user ID DB in accordance with each language or country.

As illustrated in this figure, each country (or language version) service system 20n links with each other through interface means such as Internet 11 and website and can access each others contents.

FIG. 15b is for illustrating an exemplary method of linking database build by many country (or language version) service systems with web pages and is an simplified exemplary searching web page of FIG. 5 in specific language (e.g., Korean) version selected through language selection means 112b in second embodiment of the present invention.

Numeral 15-1 is an exemplary web page for illustrating “international search” function in an Korean version IP supply Info searching web page of second embodiment, wherein when user defines each searching option by clicking with a mouse, for example, [symbol] (patent) as [symbol] (Type of IP), G06F as IPC, [symbol] (abstract) as [symbol] (Search Field) and types “intellectual property” in English as search keyword ( [symbol] ) and selects (clicks) “international search” menu, accordingly is retrieved and provided all English version IP supply Info from all English contents DBs of IP Info DB 122 built by many country (or language version) service systems including Korea (Korean) service system corresponding to search condition as described with respect to FIG. 5.

Whereas, numeral 15-2 is an exemplary web page for illustrating “domestic search” function in various language version (including Korean version) IP supply Info searching web pages of second embodiment, wherein when user defines each searching option by clicking with a mouse, for example, [symbol] (patent) as [symbol] (Type of IP), G06F as IPC, [symbol] (abstract) as [symbol] (Search Field) and types “ [symbol] ” in requested language (e.g., Korean) as search keyword ( [symbol] ) and selects (clicks) “domestic search” menu, accordingly is retrieved provided only requested language version (e.g., Korean version) IP supply Info from requested language version contents DB like Korean contents DB of IP Info DB 122 built by corresponding country (or language version) service system (e.g., Korea service system) in accordance with search condition.

Preferably the DB attribute like field of IP Info DB (at least English contents DB) built by many country (or language version) service systems in the second embodiment of the invention is same so as to have no problem to be linked with each other.

Tough FIG. 15b only illustrates the method of linking IP Info DB 122 to searching web page with respect to IP supply Info case referring to FIG. 5 but it is justly likewise applying to IP demand Info case referring to FIG. 9.

[The Third Embodiment of the Present Invention]

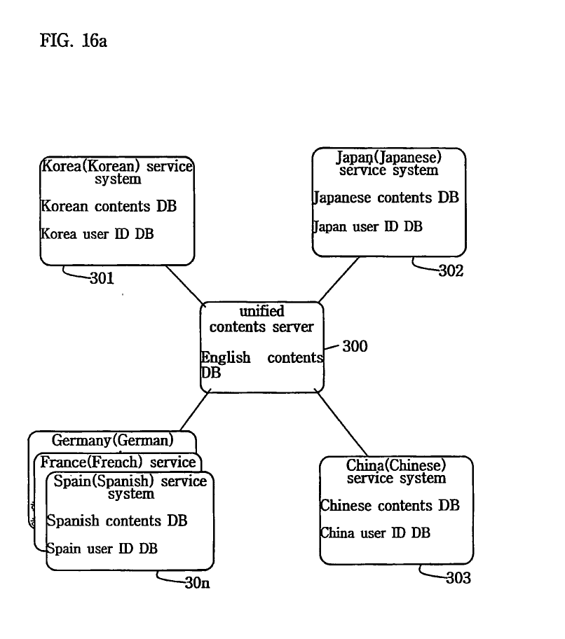

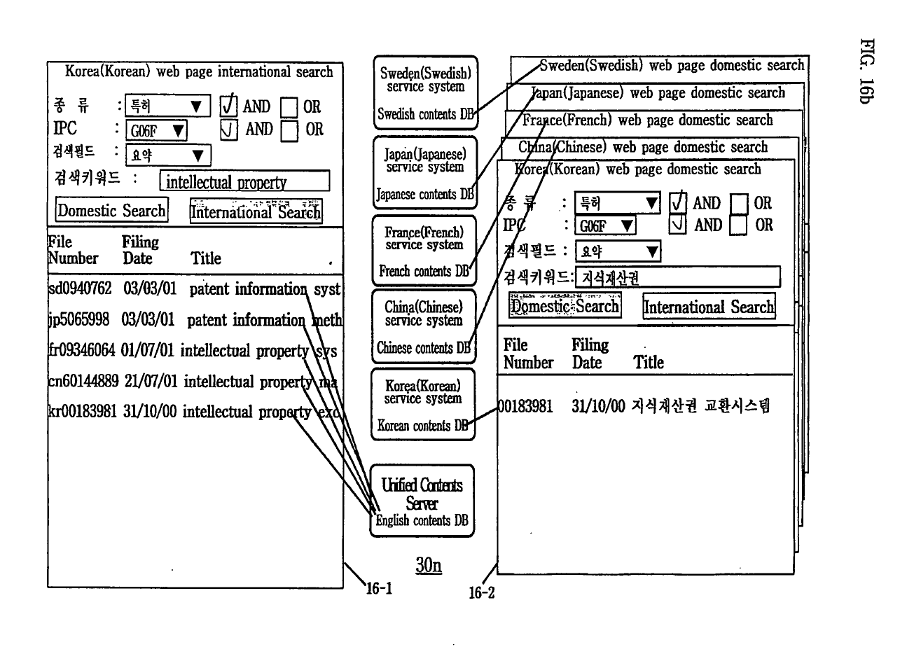

FIG. 16 is a block diagram of the system C of the third embodiment of the present invention. This embodiment differs from the second embodiment in that one unified (English version) contents providing server 300 is added to the system B of the second embodiment of the invention. The specific feature of which is that English content (DB) of IP Info DB 122 is built and provided to users in the world by one unified (English) contents providing server 300 through websites of many country (or language version) service systems 30n. That is, though each country (language version) service system 30n, 301 doesn't build English contents DB within itself but can provide to its user through said website as the interface for English contents DB of said one unified contents providing server, through which user can register, review and modify English IP Info data of IP Info DB 122.

Of course, each country (or language version) service system 30n can build its own mother language version contents DB and corresponding English contents DB within itself additionally, regardless of that of said one unified contents providing server 300. Therefore hereinafter the feature of the third embodiment is mainly described focused on the difference aspect from the second embodiment.

FIG. 16a is a diagram illustrating data linking between many service systems 30n classified by country or language and one unified (English) contents providing server 300 with respect to the third embodiment of the invention.

As described above, each illustrated country (or language version) service system 301, 302, 303, 30n operates each corresponding language version web site (home page) and also through which builds and serves to users its own mother language version IP contents DB and additionally user ID DB in accordance with each language or country but corresponding English IP contents DB doesn't establish within itself but within said one unified contents providing server 300 linking through interface means such as Internet 10 and website and from there provides its users with English contents not confining to the contents it built only.

FIG. 16b is for illustrating an exemplary method of linking English contents DB built by one unified (English) contents providing server 300 and web pages of many country (or language version) service systems 30n and is an simplified exemplary searching web page of FIG. 5 in specific language (e.g., Korean) version selected through language selection means 112b in third embodiment of the present invention. Which is also compared with the second embodiment in data searching and data linking.

Numeral 16-1 is an exemplary web page for illustrating “international search” function in an Korean version IP supply Info searching web page of third embodiment, wherein when user defines each searching option by clicking with a mouse, for example, [symbol] (patent) as [symbol] (Type of IP), G06F as IPC, [symbol] (abstract) as [symbol] (Search Field) and types “intellectual property” in English as search keyword ( [symbol] ) and selects (clicks) “international search” menu, accordingly is retrieved and provided all English version IP supply Info from English contents DB of IP Info DB 122 built by said one unified contents providing server 300 corresponding to search condition as described with respect to FIG. 5.

Whereas, numeral 16-2 is an exemplary web page for illustrating “domestic search” function in various language version (including Korean version) IP supply Info searching web pages of third embodiment, which function is the same as that of second embodiment and additional description thereof is omitted below.

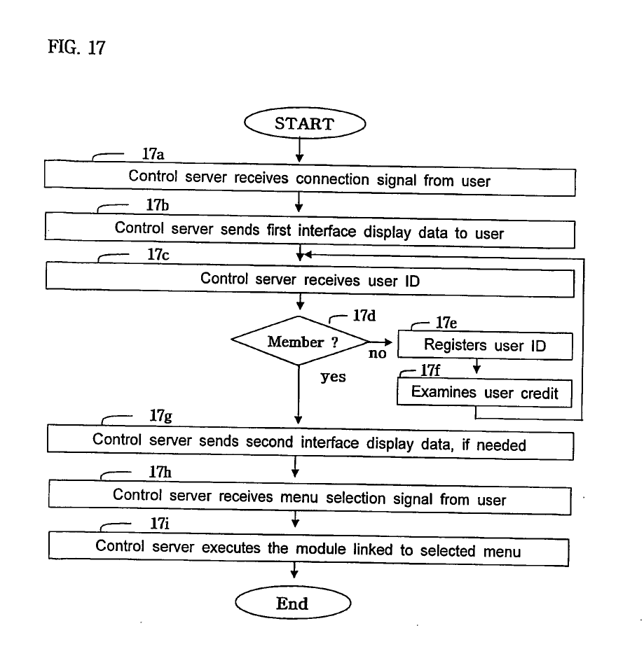

Each figure of FIG. 17 to FIG. 22 is for illustrating the method of international patent application of the present invention with respect to the system as described above.

Hereinafter in describing method of the present invention, the operation of each element (component) of control server 110 can be described shortly or omitted, for they are already described in detail above.

Hereinafter it should be understood that control server indicated in appended FIG. 17 to FIG. 22 mainly means control server 110 that performs a leading role in the said service system 100 to execute the method of the present invention but in some cases may mean said service system 100 itself and/or control functional device for whole system of the present invention.

FIG. 17 is a flowchart illustrating whole sequences of the method of filing international patent application in the present invention.

As illustrated in FIG. 17, the present invention starts when control server 110 receives connection signal from user terminal (step 17a).

Said control server sends first initial interface display data (first initial home page data) to said user terminal (step 17b).

Said control server receives user ID from user terminal through said interface (step 17c).

Said control server verifies whether said user ID is registered in user ID DB 121 through user authentication means 112d (step 17d). If said ID is registered in user ID DB 121, the process jumps to step 17g.

Said control server registers user ID accepted through user register means 112c into user ID DB 121 (step 17e).

Said control server examines credit rate regarding said registered user through credit examination means 112i and registers the resulting information into user ID DB 121 to be linked with user ID (step 17f). Said examination can be performed by service system 100 itself and/or outside credit examination agency 64 cooperatively. Next the process may go back to step 17c to log on again or go to 17g directly.

Said control server sends second interface display data (second initial home page) to said user terminal based on user ID if needed (step 17g).

Said control server receives from user terminal specific menu selection signal selected in menus provided by said interface display data (step 17h).

Said control server executes the module linked to selected menu (step 17i).

Said control server have not to receive user ID from user terminal in step 17c every time it receives connection signal from user in 17a, instead it can jump directly to step 17g after verifying he/she is a member using user ID retrieved from user terminal through user authentication means 112d following step 17a. The function of user authentication means 112d was described above in detail.

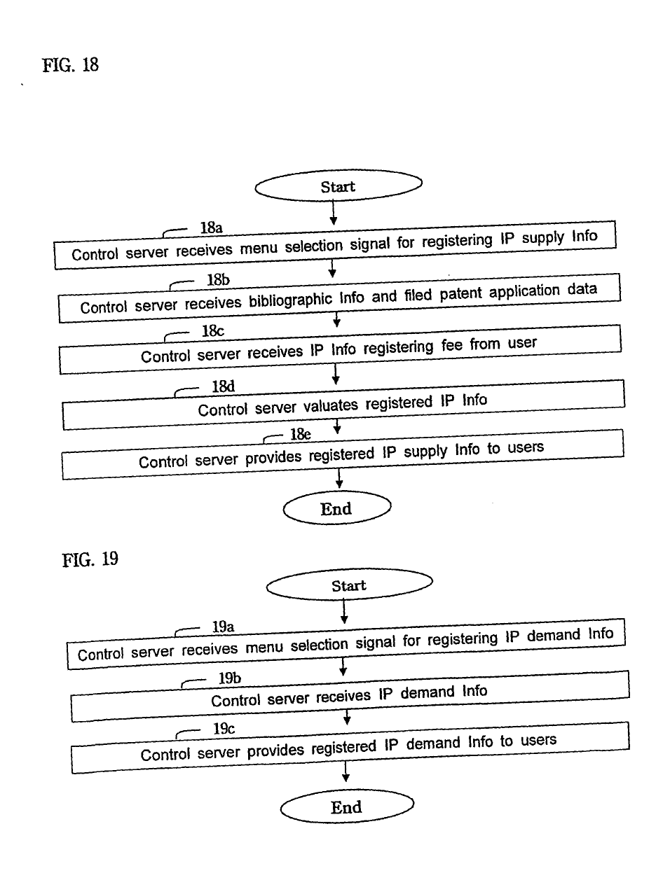

FIG. 18 is a flowchart illustrating sequences for registering specific IP supply information with respect to FIG. 17.

Said control server receives menu selection signal for registering IP supply Info from member terminal (step 18a).

Said control server receives from member terminal filed application file of specific IP Info, bibliographic information thereof and/or application file's URL through IP Info registering means like interface display (e.g., home page, etc.) (step 18b); the language used for bibliographic Info and filed application of said IP supply Info comprises one or more among filed languages and English. Said IP Info is mainly registered through IP supply means 112e.

Said control server receives registering fee for registering IP Info from member through billing means 112k (step 18c).

Said control server valuates said registered IP Info through IP valuation means 112j and registers valuated Info thereof into IP Info DB 122 (step 18d). Said IP valuation step is omitted, if needed.

Said control server provides to users said registered IP Info, its filed application file, its IP valuation Info and/or its translation Info through IP supply means 112e with respect to user request (step 18e).

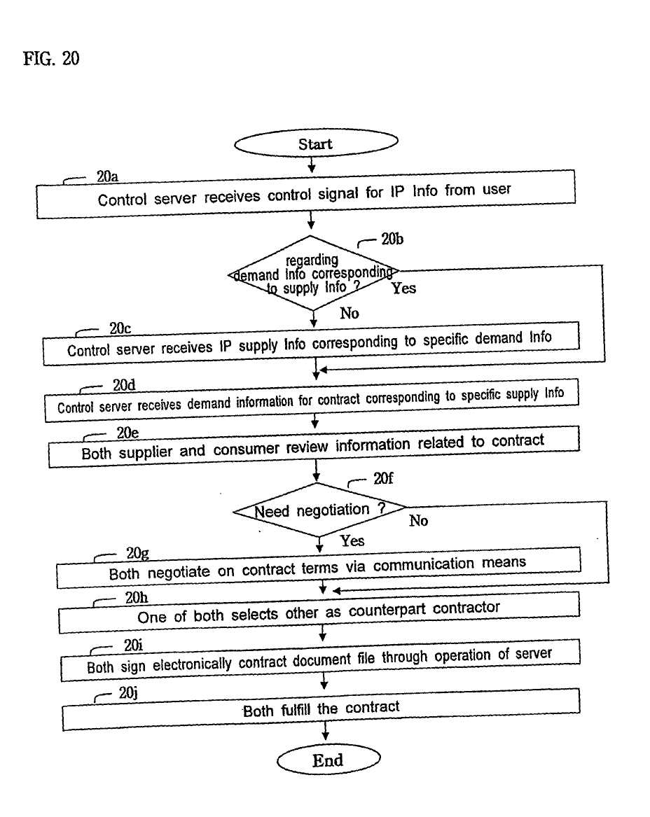

FIG. 19 is a flowchart illustrating sequences for registering specific IP demand information with respect to FIG. 17.

Said control server receives menu selection signal for registering IP demand Info from member terminal (step 19a).

Said control server receives from member terminal specific IP demand Info through IP demand Info registering means like interface display (e.g., home page, etc.) (step 19b); the language used for said IP demand Info comprises one or more among languages supported by said service system 100.

Said control server provides to users said registered IP demand Info through IP demand means 112f with respect to user request (step 19c).

FIG. 20 is a flowchart illustrating whole sequences for making contract of electronic commerce for IP information with respect to FIG. 17.

Said control server receives control signal for specific IP supply or demand Info from user terminal through IP supply means 112e or IP demand means 112f (step 20a).

Said control server verifies whether said received signal relates to specific IP demand Info corresponding to specific IP supply Info, and if it does, then the process jumps to step 20d (step 20b). Wherein verification can be done, for example, by verifying whether the signal is received through specific IP supply Info reviewing web page as FIG. 6.

Said control server receives specific IP supply Info corresponding to specific IP demand Info from member terminal through information transmission means as FIG. 7 (step 20c).

Said control server receives a demand Info for contract including contract terms corresponding to specific IP supply Info from member terminal through information transmission means made by a technology as in FIG. 11 (step 20d). Which step can be omitted if the process has come through step 20c.

Supplier or consumer of specific IP Info receives a request Info for contract including contract terms corresponding to specific IP supply or demand Info from control server and reviews it to select counterpart contractor (step 20e), wherein the process of sending request Info by control server can be performed through IP supply means 112e and/or IP demand means 112f and said reviewing is performed through web pages like FIG. 13.

The process jumps to step 20h if Supplier or consumer of specific IP supply or demand Info do not consider negotiating as to contract terms after reviewing a request Info for contract including contract terms in step 20e (step 20f).

Both supplier and consumer of specific IP Info negotiates as to contract terms through communication means (e.g., chatting, SMS, IM, mail, wire/wireless telephone, etc.) linked to contractor selection means like FIG. 13 (step 20g).

Supplier or consumer of specific IP supply Info selects counterpart contractor among potential counterpart contractors like supplier or consumers of relevant IP supply or demand Info and sends selected Info to control server, then control server stores said selected Info into IP Info DB 122 to be linked with related IP supply Info and/or IP demand Info (step 20h), wherein selecting counterpart contractor can be performed through contracting means 112h.

Said control server performs the process of making contract for requested IP Info between contractors through contracting means 112h (step 20i).

Both contractors fulfills the contract in accordance with contract terms (step 20j), wherein said contract terms can be such as filing patent application in foreign, trade, ownership exchange of IP/license, etc., license, payment of filing fee and reward thereof, etc Step 20e to step 20h can be performed by contractor selection means 112g.

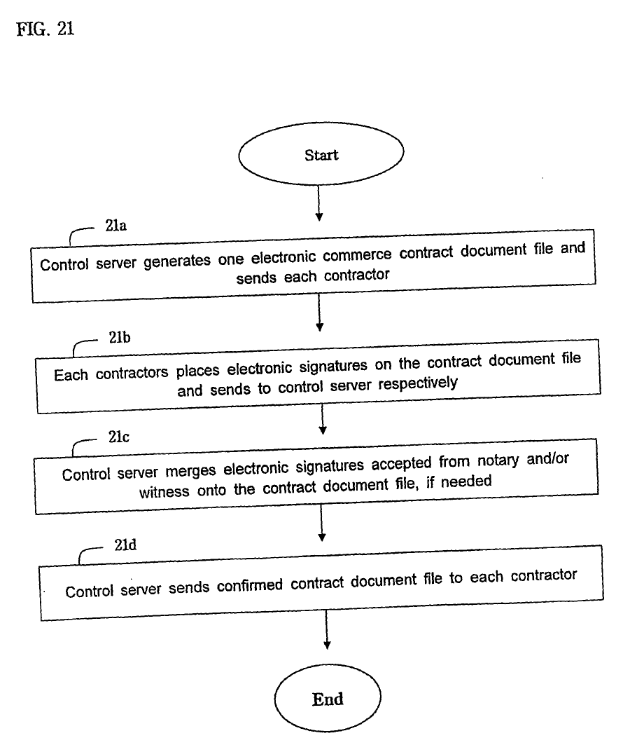

FIG. 21 is a flowchart illustrating sequences for making contract document of electronic commerce for IP information with respect to FIG. 20.

But description about this process has been already described in detail with respect to contracting means 112h, so hereinafter will be described in short.

Said control server generates one electronic commerce contract document display file for filing patent application as FIG. 14 and sends to each contractor in predetermined sequence through said terminals (step 21a).

Said each contractor reviews said contract document file, places electronic signature on it and sends to said control server (step 21b).

Said control server merges electronic signatures accepted from the predetermined notary 60 and/or witness like owner of said service system onto said confirmed contract document file (step 21c). Which step can be omitted if it is needed.

Said control server stores into IP Info DB 122 said contract document file as a confirmed contract document file for filing application of IP Info and sends to each contractor through said user terminals (step 21d). Wherein transmitted contract document file is stored into said user terminal and/or printed through printer connected thereto.

[The Fourth Embodiment of the Present Invention]

The fourth embodiment of the present invention relates to filing application of non-disclosed IP Info in foreign countries in secret manner, except which this embodiment is same as other embodiments described above, so regarding same techniques will be described in short.

The main problem for this embodiment to solve is that since non-disclosed IP Info should be kept in secret state, so the IP Info can not be publicly accessed by consumer and valuated and accordingly also counterpart contractor for filing in foreign country can not be found publicly as in other embodiment.

To solve the above mentioned problem, many cooperative companies using the present invention, each located in each country (or mother tongue country) owned mainly by law firm, patent agency and/or IP intermediary company, etc. (hereinafter may be referred to this kind company as “cooperative company”), agree with each other to cooperatively provide said users with international patent service through the service systems of the present invention linked with each other via Internet. Said agreed cooperation terms mainly relates to service fee including patent application fee, patent agency designation fee, etc., based on each service and everything required for filing international application service.

For this embodiment each service system is additionally equipped with a menu for filing non-disclosed IP patent application onto initial home page as FIG. 4 through which to provide users with an electronic version of information with respect to patent institution and filing fee of requested country according to user's request and to receive from said user terminals a request for filing patent application in one or more foreign country together with an electronic version of non-disclosed IP Info.

The language of which application is in English or requested country's language and if needed, said service system translates into requested language version. Said service fee is charged in accordance with designating agency or not, demanding examination of application or not, amount of pages of application, and/or translation into requested country's language or not, etc.

One feature of this embodiment is that if there are countries like Korea that allow applicant to file patent application without demand of examination at first filing stage, applicant can file many patent applications at the same time in these countries through said service system using the present invention and can have period for predetermined time to determine afterwards whether to demand examination of application or not after investigating the possibility of obtaining patent and commercialization in filed countries, so can reduce patent related expense.

Other feature of this embodiment is that seemingly the process of filing application of non-disclosed IP Info through this embodiment is same as that of the prior art, but actually very much different from between the two in that the international application by the prior art is performed in non-automatic way through cooperative intermediary of related patent agencies in relationship between each other, for that reason, prior art can not provides user with information such as updated patent institutes, etc., about requested countries sufficiently, automatically and rapidly and moreover has difficulty in providing various fee options different from each other based on patent related service types that user can choose in accordance with his/her need and circumstances, whereas, this embodiment can solve easily the problem of the prior art in the way as described above (i.e., through cooperative intermediary between service systems themselves (using the present invention) of many cooperative companies in relationship between each other unlike prior art) so to be able to provide better patent service at a lower cost, conveniently, rapidly and automatically.

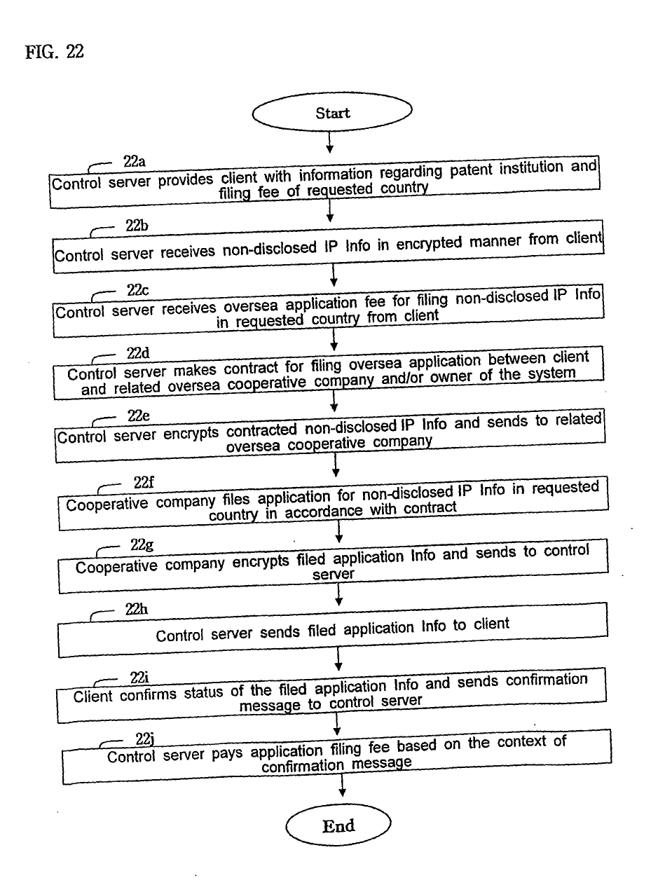

FIG. 22 is a flowchart illustrating sequences for filing international patent application of non-disclosed IP information by the method of the fourth embodiment of the present invention.

Said control server provides to client (user or IP supplier, hereinafter may be refereed as client) terminal with information regarding patent institution and filing fee of requested country and non-disclosed IP Info transmission means for filing non-disclosed IP info international patent application in accordance with user's request (step 22a). Said information regarding patent institution and filing fee of requested country can be provided in other steps of this embodiment and said transmission means can be embodied in the form of web/DB application module using the techniques as illustrated in FIG. 7. And said request for filing non-disclosed IP Info international patent application can be executed through a menu (e.g., entitled as Filing non-disclosed IP Info international patent application”) added additionally to initial home page as FIG. 4 and related module linked therewith.

Said control server receives non-disclosed IP Info in encrypted manner from client terminal (step 22b). Said non-disclosed IP Info consists of encrypted application file in English or requested filing country language, and contract terms and bibliographic information of said application which are not encrypted and can be read in plain (original) encoding format, so it is preferable that said non-encrypted information does not includes abstract of non-disclosed IP Info. And preferably the public key used for encrypting said non-disclosed IP Info by PKI (Public Key Infrastructure) technology is related country cooperative company's and provided by said service system at encrypting event. And said service system can provides translation service of application into requested language version, in which case can charge additional fee for that.

Said control server receives oversea application fee for filing non-disclosed IP Info in requested country through billing means 112k from client (step 22c). Said fee includes application fee in requested country and service fee of said service system for filing application service.

Said control server makes contract for filing oversea application between client and related oversea cooperative company and/or owner of the system through contracting means 112h (step 22d). If counterpart contractor is owner of said service system, said owner has a responsibility for filing patent application in requested country in cooperation with related cooperative company and providing client with resulting Info including filed application, whereas, If counterpart contractor is related cooperative company, said owner of the service system has a responsibility for providing intermediary service for helping fulfilling contract by said cooperative company. And the terms of said contract comprises one or more among filing country, designation of patent agent, due filing date, applicant name, demand of examination, international application filing fee, court at dispute, etc.

Said control server of said service system (intermediary server system) encrypts contracted non-disclosed IP Info and other related Info by its private key of PKI technology and sends to related oversea cooperative company (step 22e).

Said cooperative company files application for non-disclosed IP Info in requested country in accordance with contract (step 22f). Before filing, said cooperative company decrypts encrypted file by public key of PKI technology of client and/or said service system, and translates into requested language version if needed, and edits and/or amends said IP Info, if needed, in accordance with requested country's patent rules.

Said cooperative company encrypts filed resulting Info including filed application and sends to control server via Internet (step 22g). For encryption, preferably public key of client and/or said intermediary service system are used and provided from said intermediary service system. Regardless of said sending resulting Info via Internet, said oversea cooperative company can send to client printed version of filed application via international postal mailing system.

Said control server sends filed application Info to client (step 22h).

Said client decrypts said filed application Info through electronic signature and encryption module 40b of said user terminal 40, confirms status of the filed application Info and sends confirmation message to control server (step 22i).

Said control server pays application filing fee in accordance with the context of said confirmation message that there is no problem in filed application Info (step 22j). Said confirmation can be performed by comparing said filed application Info with contract document.

In step 22i and step 22j, the process of confirmation of status of the filed application Info can be omitted if needed, in which case the process of paying application filing fee in step 22j can be performed exactly after step 22g or step 22h.

This embodiment also can be applied to filing application in the countries that are not members of international organization related to patent like WIPO regardless of filed in one country or not, which can be understood to those skilled in the art.

Identification information of oversea cooperative companies should be built into database additionally and preferably comprises identification Info (e.g., company ID, address, phone number, etc.), digital certificate Info, credit examination Info, filing service fee, and/or country patent institution Info, etc., according to each cooperative company.

In each embodiment, preferably the language used for all disclosed Information is English and/or the language of the country to be filed in.

The language used in each embodiment is preferably unified as English, in which case each country (or language) service system preferably provides language translation service into English to user.

Preferably the form of filed application in at least one country that is translated into English version is PCT application form.

Tough translation service by said translation means 113m has been described above on focused of English translation service but should not be confined to that because it can be applied to other language used for international communication.

In case of filing international patent application in each embodiment, though there in contract document is no special contract terms, consumer as counterpart contractor can require supplier to give additional Info to be needed for obtaining patent in requested country, and edit and amend application, if needed, in accordance with patent rule of requested country and negotiation between contractors.

In each embodiment, the scope of encrypted information should not be confined to those described above, but can include other information in accordance with the decision of said service system owner.

In each embodiment, kinds of IP supply or demand Info searching web pages should not be confined to those described above, but can include various kinds of web pages including category type searching web pages and category/keyword combination type searching web pages.

In each embodiment, applicant name in contract terms for filing patent application can be many for partnership application.

Till now, the present invention has been described in detail. However, it should be understood that said detailed description and specific examples (which indicate preferred embodiments of the invention) are given by way of illustration only, since various changes and modifications within the spirit and scope of the invention will become apparent to those killed in the art from this detailed description, so the actual scope of the invention should be determined with reference to the appended claims along with their full scope of equivalents and alternatives.

### INDUSTRIAL APPLICABILITY

1. The present invention provides a useful technology to file patent application of IP Info, which has been filed in one patent office, in foreign country in cooperation with the resident consumer of IP Info living in filing country at a lower cost, conveniently and efficiently.

2. The present invention provides a useful technology that enables IP supplier to cope better with the examination (prosecution) procedure and with patent institution of requested country and to determine better the possibility of commercialization in requested country than in the prior art, that is why IP Info is filed for patent in the requested foreign country, not by the original applicant of the priority patent application, but by the resident consumer living in the requested country who wants to practice the invention in his/her country for his/her profit in his/her responsibility and/or name.

3. The present invention provides a useful technology that enables IP supplier does not pay (or pay little) a fee for patent agent designation in his/her mother land or foreign country for filing patent application in foreign country not like as in the prior art.

4. The present invention provides a useful technology that facilitates electronic commerce worldwide of IP Info that has been filed in one patent office.

5. The present invention provides a useful technology that facilitates to attract fund and partners from the world needed to commercialize the IP Info in the process of electronic commerce.

6. The present invention provides a useful technology as platform that facilitates to early commercializing IP Info in various countries so as to promote the public recognition of IP Info in global market at a lower cost.

7. The present invention provides a useful technology that facilitates to confront the infringement of the issued patent from foreign country more directly and more efficiently by a resident consumer as contractor living in patent filing country than by applicant of prior patent application as in the prior art.

1. A system for filing patent application of IP Info in foreign countries including user terminals and computer-implemented service system connected with Internet,
said service system comprising:
(a) means for receiving from said user terminals a request for filing patent application in one or more foreign country together with an electronic version of non-disclosed IP Info;
(b) means for receiving from said user the patent application fee for said IP Info filing and the service fee based on each filing service of said service system; and
(c) means for making contract of filing patent application in requested country and fulfilling the contract in cooperation with the cooperative company located in the related country;
wherein said user has membership in said service system and membership information is registered in the storage device associated with said service system,
said IP Info relates to one of patent, design patent, trademark, utility model and has not been in disclosure wherein the language used for said non-disclosed IP Info is English or/and the requested country's language,
said cooperative company agrees with other companies to provide said users with international patent service through the service system of the present invention linked with each other via Internet.

2. The system of claim 1 wherein said means (a) comprises means for providing users with the translation service for said IP Info into English or requested country's language version according to user's request, said service fee of said means (b) further comprises said translation service fee.

3. The system of claim 1 wherein said service system further comprising means for providing users with an electronic version of information with respect to patent institution and filing fee of requested country according to user's request.

4. The system of claim 1 wherein the terms of said contract comprises one or more among filing country, designation of patent agent, due filing date, applicant name, demand of examination, filing fee, court at dispute, etc.

5. The system of claim 1 wherein said means (c) comprises:
(c1) means for making contract of filing patent application in requested country between said user and owner of said service system or said related cooperative company;
(c2) means for sending said IP Info to said related cooperative company;
(c₃) means for receiving the filed application information from said related cooperative company;
(c₄) means for paying said patent application filing fee to said related cooperative company.

6. The system of claim 5 wherein said means (c3) comprises means for sending the filed application information to related user.

7. The system of claim 6 wherein said patent application filing fee is paid after receiving from said user the message that there is no problem in said filed application information.

8. A system for filing patent application of IP Info in foreign countries including user terminals and computer-implemented service system connected with Internet,
said service system comprising:
(a) means for electronically receiving the supply information of IP Info from said user terminal, registering into the storage device and providing to said user terminals;
(b) means for electronically receiving the demand information of specific IP Info from said user terminal, registering into the storage device and providing to said user terminals;
(c) means for electronically selecting contractors for electronic commerce contract of specific IP Info; and
(d) means for electronically making contract for electronic commerce of said specific IP Info and fulfilling said contract;
wherein said IP supply Info relates to one of patent, design patent, trademark, utility model, and comprises filed application data in one or more country, bibliographic information thereof and contract terms for electronic commerce,
wherein said IP Info demand information relates to the contract terms corresponding to said registered specific IP supply Info or the contract terms including the identification information and the reward information for the specific IP Info not registered yet in said service system to be provided based on buyer initiative auction,
wherein the language used for the supply and demand information of said IP Info and for said contract comprises English.

9. The system of claim 8 wherein said service system further comprising:
(e) means for electronically registering membership information, retrieving and modifying it by user through said user terminal; and
(f) means for electronically certifying membership when user logs on.

10. The system of claim 9 wherein said means (e) comprises means for examining credit rate regarding said registered user, registering the resulting information into said storage device and providing to other users, and wherein said examined credit rate can be adjusted according to the points resulting from user's utilization of said service system.

11. The system of claim 8 wherein said service system further comprising:
(g) means for receiving from users the fee for registering said supply information of IP Info, and/or for helping to make contract for electronic commerce between supplier and consumer of said registered IP Info.

12. The system of the claim 8 wherein said means (a) comprises means for registering into said storage device and providing to user terminals the IP asset valuation information of said registered IP Info valuated by IP valuation means which is a well known IP asset valuation computer program or a way like analyzing user's opinion regarding said registered IP Info written in a bulletin web-board and/or analyzing users' retrieval counting of it.

13. The system of claim 8 wherein said service system further comprising:
(h) means for retrieving the IP supply or demand information stored in the said storage device and corresponding to or similar to searching keyword or identification information registered by supplier or consumer and providing to potential supplier or potential consumer;
wherein said means (h) is one or more among e-mail, SMS, IM, web-mail, various kinds of web pages for IP supply/demand Info.

14. The system of claim 8 wherein means for providing the supply or demand information of IP Info stored in said storage device comprises pulling type and pushing type data transmission technology such as e-mail, SMS, messenger, web-mail, various kinds of web pages for IP supply/demand Info.

15. The system of claim 14 wherein said supply/demand web page for IP Info is a contents providing means for providing the information with the attributes corresponding to user's request.

16. The system of claim 14 wherein said web supply/demand page comprises a providing means for the information automatically retrieved from said storage device and corresponding to specific supply or demand information of IP Info registered by said registered user.

17. The system of claim 8 wherein selecting contractors of said means (c) is performed in one of the following methods:
an auction method in which supplier of specific IP Info selects appropriate consumer as counterpart contractor and sends the selected information to said service system through said user terminal after receiving and referring the demand information with respect to that IP supply Info including the terms information of contract and/or corresponding consumer profile information which are registered in the said service system;
a consumer initiative auction method in which potential consumer of specific IP Info selects appropriate supplier as counterpart contractor and sends the selected information to said service system through said user terminal after receiving and referring the supply information with respect to that IP demand Info including the terms information of contract and/or corresponding supplier profile information which are registered in the said service system;
an automation method in which said service system automatically selects contractors by a computer program module for selecting contractors based on the contract terms information with respect to the supply or demand information of specific IP Info and/or on corresponding supplier and consumer profile information.

18. The system of claim 17 wherein said auction method or consumer initiative auction method comprises the step of negotiating between contractors regarding contract terms through wire or wireless communication means.

19. The system of claim 17 wherein said demand information for specific IP Info requested to be provided in said consumer initiative auction method comprises one or more among bibliographic information, searching keyword for said demand information, contract terms for filing patent application, reward terms with respect to specific IP Info, countries to be filed in, etc.

20. The system of one of claims 1 to 19 wherein the process of filing patent application in requested country by the consumer as contractor comprises the steps of:
translating the filed IP Info into requested language version, if needed; and editing and/or amending said IP Info, if needed, according to requested country's patent rules.

21. The system of one of claims 1 to 19 wherein said making contract is performed in the method in which said service system electronically generates one electronic commerce contract document file and merges onto it electronic signatures accepted from each related contractors through said user terminals.

22. The system of one of claims 1 to 19 wherein the process of making contract comprises the steps of:
electronically generating one electronic commerce contract document file and sending in the predetermined order to each related contractor respectively;
said each contractor reviewing said contract document file, placing electronic signature on it and sending to said service system respectively; and
registering into said storage device said contract document file having contractors' electronic signatures as the electronic commerce contract document for specific IP Info.

23. The system of claim 22 wherein said electronic commerce contract document file is generated by combining an related contract document template file with contractors' profiles, bibliographic information for specific IP Info and contract terms determined by contractors and retrieved from said storage device.

24. The system of claim 22 further comprises the step of:
sending to related contractors said registered electronic commerce contract document file through said user terminals.

25. The system of claim 22 further comprises the step of:
merging electronic signatures accepted from the predetermined notary and/or witness onto said registered electronic commerce contract document file.

26. The system of one of claims 1 to 19 wherein the construction and operation type of said service system is one among one unified system, a linking system between various service systems classified by country or language, a linking system between one unified contents providing server and various service systems classified by country or language;
wherein there both between various service systems and between one unified contents providing server and various service systems classified by country or language are fixed data linking channels.

27. The system of claim 26 wherein the contents including the IP Info provided by said service system are provided as following ways:
in the construction case of one unified system, it provides all contents including various language versions and corresponding English version;
in the construction case of a linking system between various service systems, each service system provides its native language version only and corresponding English version;
in the construction case of a linking system between one unified contents providing server and various service systems, specific language version is provided by each language service system and English version corresponding to said specific language version is provided by said one unified contents providing server.

28. The system of one of claims 1 to 19 wherein said storage device comprises data storage module, wherein said data storage module comprises one or more database consisted of various data attributes including membership information, IP Info, payment information, etc.

29. The system of one of claims 8 to 19 wherein the reward given by the supplier of the specific IP Info to counterpart contractor for filing international patent application comprises one or more among transferring all or part of patent ownership, transferring denomination of ownership, partnership patent application, reward for obtaining patent, offering license for issued patent, patent application fee, etc.

30. The system of claim 29 wherein if said reward is transferring all or part of patent ownership or transferring denomination of ownership, said counterpart contractor gives to the supplier of the specific IP Info the reward with one or more among license, transferring part of patent ownership, reward with money, exchange with other IP, offering use rights for issued patent, etc. after obtaining patent from designated country.

31. The system of one of claims 8 to 19 wherein the language used for said registered IP supply and demand information is English only, non-English only, or both English and non-English.

32. The system of claim 31 wherein said service system further comprising means for translating said filed IP Info into English version and registering in said storage device to be linked with original version if it is non-English.

33. The system of claim 31 wherein said service system further comprising means for translating said filed IP Info into English version by predetermined expert translator or automatic translation computer program and registering in said storage device to be linked with original version if it is non-English.

34. The system of one of claims 1 to 19 wherein said IP Info comprises the application already filed in one country for rights, said one country comprises nations coalition like UN, EU, etc., and region like Africa, etc.

35. The system of one of claims 8 to 19 wherein said consumer of IP Info comprises one or more among individual, corporation, business firm, government agency, patent representative like patent attorney or patent agent, Investment and Finance Corporation and owner of said service system.

36. The system of one of claims 1 to 19 wherein the contents of said international filing contract comprises one or more among bibliographic information of related IP Info, identification information of applicant, terms of contract, rewards to counterpart contractor, application filing fee, court at dispute, etc.

37. The system of one of claims 8 to 19 wherein said electronic commerce relates to dealing of specific IP Info, exchange with other IP, exchange with other license, transferring denomination of ownership, transferring patent ownership, transferring partial patent ownership and/or contract for filing international patent application, etc.

38. The system of one of claims 1 to 19 wherein the document form of said IP Info written in English or the language of the requested country for filing patent application is like PCT patent application.

39. The system of one of claims 1 to 19 wherein the important information is transmitted in encrypted format between said user terminal and said service system.

40. The system of one of claims 1 to 19 wherein said user terminal is equipped with various computer programs executing on Internet based computer, officially-approved user digital certificate, electronic signature and encryption means; said electronic signature and encryption means is downloaded from said service system and is installed in itself.

41. The system of one of claims 1 to 19 wherein said service system provides user with the customized language version interface display file in one of the following methods after user connects with said service system:
(a) the method in which said service system provides user with the first interface display file in default language version, then provides said customized language version interface display file after verifying user's language use information stored in said storage device through the log-on means of said first interface display file;
(b) the method in which said service system directly provides said customized language version interface display file after verifying user's default language use information of the attribute information file stored in predetermined section of the storage device of said user terminal.
(c) the method in which said service system directly provides said customized language version interface display file after verifying user's default language use information of said attribute information file including user's language use classification code;
wherein said attribute information file comprises cookie file.

42. The system of one of claims 5 to 7 wherein said non-disclosed IP Info and said filed patent application information to be sent or received are encoded into encrypted format codes and are decoded into original format document by said terminals of user and cooperative company respectively.

43. The system of claim 42 wherein said non-disclosed IP Info is encoded into encrypted format codes using public key of the requested country's cooperative company and said filed application information is encoded into encrypted format codes using public key of related user.

44. A method, implemented using the system including user terminals and computer-implemented service system connected with Internet, for filing patent application of IP Info in foreign countries, comprising the steps of:
(a) receiving from said user terminals a request for filing patent application in one or more foreign country together with an electronic version of non-disclosed IP Info;
(b) receiving from said user the patent application filing fee for said IP Info and the service fee based on each filing service of said service system; and
(c) making contract of filing patent application in requested country and fulfilling the contract in cooperation with cooperative company located in the related country;
wherein said user has membership in said service system and membership information is registered in the storage device associated with said service system,
said IP Info relates to one of patent, design patent, trademark, utility model and has not been in disclosure wherein the language used for said non-disclosed IP Info is English or/and the requested country's language,.
said cooperative company agrees with other companies to provide said users with international patent service through the service system of the present invention linked with each other via Internet.

45. The method of claim 44 wherein said step (a) comprises the step of providing users with the translation service for said IP Info into English or requested country's language version according to user's request, said service fee of said step (b) further comprises said translation service fee.

46. The method of claim 44 wherein one of steps comprises the step of providing users with an electronic version of information with respect to patent institution and filing fee of requested country according to user's request.

47. The method of claim 44 wherein the terms of said contract comprises to one or more among filing country, designation of patent agent, due filing date, applicant name, demand of examination, filing fee, court at dispute, etc.

48. The method of claim 44 wherein said step (c) comprises the steps of:
(c1) making contract of filing patent application in requested country between said user and owner of said service system or said related cooperative company;
(c2) sending said IP Info to said related cooperative company;
(c3) receiving the filed application information from said related cooperative company; and
(c4) paying said patent application filing fee to said related cooperative company.

49. The method of claim 48 wherein said step (c₃) comprises the step of sending the filed application information to related user.

50. The method of claim 49 wherein said patent application filing fee is paid after receiving from said user the message that there is no problem in said filed application information.

51. A method, implemented using the system including user terminals and computer-implemented service system connected with Internet, for filing patent application of IP Info in foreign countries, comprising the steps of:
(a) electronically receiving the supply information of IP Info from said user terminal, registering into the storage device and providing to said user terminals;
(b) electronically receiving the demand information of specific IP Info from said user terminal, registering into the storage device and providing to said user terminals;
(c) electronically selecting contractors for electronic commerce contract of specific IP Info; and
(d) electronically making contract for electronic commerce of said specific IP Info and fulfilling said contract;
wherein said IP supply Info relates to one of patent, design patent, trademark, utility model, and comprises filed application data in one or more country, bibliographic information thereof and contract terms for electronic commerce,
wherein said IP demand Info relates to the contract terms corresponding to said registered specific IP supply Info or the contract terms including the identification information and the reward information for the specific IP Info not registered yet in said service system to be provided based on buyer initiative auction,
wherein the language used for the supply and demand information of said IP Info and for said contract comprises English.

52. The method of claim 51 further comprising the steps of:
(e) electronically registering membership information, retrieving and modifying it by user through said user terminal; and
(f) electronically certifying membership when user logs on.

53. The method of claim 52 wherein said step (e) comprises the step of examining credit rate regarding said registered user, registering the resulting information into said storage device and providing to other users, and wherein said examined credit rate can be adjusted according to the points resulting from user's utilization of said service system.

54. The method of claim 51 further comprising the step of:
(g) receiving from users the fee for registering said supply information of IP Info, and/or for helping to make contract for electronic commerce between supplier and consumer of said registered IP Info.

55. The method of the claim 51 wherein said step (a) comprises the step of registering into said storage device and providing to user terminals the IP asset valuation information of said registered IP Info valuated by IP valuation means which is a well known IP asset valuation computer program or a way like analyzing user's opinion regarding said registered IP Info written in a bulletin web-board and/or analyzing users' retrieval counting of it.

56. The method of claim 51 wherein said contract fulfilling step (d) comprises the step of one contractor rewarding other contractor for fulfilling the contract in accordance with contract terms.

57. The method of claim 51 further comprising the step of:
(h) retrieving the IP supply or demand information stored in the said storage device and corresponding to or similar to searching keyword or identification information registered by supplier or consumer and providing to potential supplier or potential consumer;
wherein said step (h) is performed through one or more among e-mail, SMS, IM, web-mail, various kinds of web pages for IP supply/demand Info.

58. The method of claim 51 wherein the technology for providing the supply or demand information of IP Info stored in said storage device comprises pulling type and pushing type data transmission technology such as e-mail, SMS, messenger, web-mail, various kinds of web pages for IP supply/demand Info.

59. The method of claim 58 wherein said supply/demand web page for IP Info is a contents providing means for providing the information with the attributes corresponding to user's request.

60. The method of claim 58 wherein said web supply/demand page comprises a providing means for the information automatically retrieved from said storage device and corresponding to specific supply or demand information of IP Info registered by said registered user.

61. The method of claim 51 wherein selecting contractors of said step (c) is performed in one of the following ways:
the auction way in which supplier of specific IP Info selects appropriate consumer as counterpart contractor and sends the selected information to said service system through said user terminal after receiving and referring the demand information with respect to that IP Info supply information including the terms information of contract and/or corresponding consumer profile information which are registered in the said service system;
the consumer initiative auction way in which consumer of specific IP Info selects appropriate supplier as counterpart contractor and sends the selected information to said service system through said user terminal after receiving and referring the supply information with respect to that IP demand Info including the terms information of contract and/or corresponding supplier profile information which are registered in the said service system;
the automation way in which said service system automatically selects contractors by a computer program module for selecting contractors based on the contract terms information with respect to the supply or demand information of specific IP Info and/or on corresponding supplier and consumer profile information.

62. The method of claim 61 wherein said auction way or consumer initiative auction way comprises the process of negotiating between contractors regarding contract terms through wire or wireless communication means.

63. The method of claim 61 wherein said demand information for specific IP Info requested to be provided in said consumer initiative auction way comprises one or more among bibliographic information, searching keyword for said demand information, contract terms for filing patent application, reward terms with respect to specific IP Info, countries to be filed in, etc.

64. The method of one of claims 44 to 63 wherein the process of filing patent application in requested country by the consumer as contractor comprises the steps of:
translating the filed IP Info into requested language version, if needed; and
editing and/or amending said IP Info, if needed, according to requested country's patent rules.

65. The method of one of claims 44 to 63 wherein said making contract is performed in the way in which said service system electronically generates one electronic commerce contract document file and merges onto it electronic signatures accepted from each related contractors through said user terminals.

66. The method of one of claims 44 to 63 wherein the step of making contract comprises the steps of:
electronically generating one electronic commerce contract document file and sending in the predetermined order to each related contractor respectively;
said each contractor reviewing said contract document file, placing electronic signature on it and sending to said service system respectively; and
registering into said storage device said contract document file having contractors' electronic signatures as the electronic commerce contract document for specific IP Info.

67. The method of claim 66 wherein said electronic commerce contract document file is generated by combining an related contract document template file with contractors' profiles, bibliographic information for specific IP Info and contract terms determined by contractors and retrieved from said storage device.

68. The method of claim 66 further comprises the step of:
sending to related contractors said registered electronic commerce contract document file through said user terminals.

69. The method of claim 66 further comprises the step of:
merging electronic signatures accepted from the predetermined notary and/or witness onto said registered electronic commerce contract document file.

70. The method of one of claims 44 to 63 wherein the construction and operation type of said service system is one among one unified system, a linking system between various service systems classified by country or language, a linking system between one unified contents providing server and various service systems classified by country or language;
wherein there both between various service systems and between one unified contents providing server and various service systems classified by country or language are fixed data linking channels.

71. The method of claim 70 wherein the contents including the IP Info provided by said service system are provided as following ways:
in the construction case of one unified system, it provides all contents including various language versions and corresponding English version;
in the construction case of a linking system between various service systems, each service system provides its native language version only and corresponding English version;
in the construction case of a linking system between one unified contents providing server and various service systems, specific language version is provided by each language service system and English version corresponding to said specific language version is provided by said one unified contents providing server.

72. The method of one of claims 44 to 63 wherein said storage device comprises data storage module, wherein said data storage module comprises one or more database consisted of various data attributes including membership information, IP Info, payment information, etc.

73. The method of one of claims 51 to 63 wherein the reward given by the supplier of the specific IP Info to counterpart contractor for filing international patent application comprises one or more among transferring all or part of patent ownership, transferring denomination of ownership, partnership patent application, reward for obtaining patent, offering license for issued patent, patent application fee, etc.

74. The method of claim 73 wherein if said reward is transferring all or part of patent ownership or transferring denomination of ownership, said counterpart contractor gives to the supplier of the specific IP Info the reward with one or more among license, transferring part of patent ownership, reward with money, exchange with other IP, offering use rights for issued patent, etc. after obtaining patent from designated country.

75. The method of one of claims 51 to 63 wherein the language used for said registered IP supply and demand information is English only, non-English only, or both English and non-English.

76. The method of claim 75 further comprising the step of translating said filed IP Info into English version and registering in said storage device to be linked with original version if it is non-English.

77. The method of claim 75 further comprising the step of translating said filed IP Info into English version by predetermined expert translator or automatic translation computer program and registering in said storage device to be linked with original version if it is non-English.

78. The method of one of claims 44 to 63 wherein said IP Info comprises the application already filed in one country for rights, said one country comprises nations coalition like UN, EU, etc., and region like Africa, etc.

79. The method of one of claims 51 to 63 wherein said consumer of IP Info comprises one or more among individual, corporation, business firm, government agency, patent representative like patent attorney or patent agent, Investment and Finance Corporation and owner of said service system.

80. The method of one of claims 44 to 63 wherein the contents of said international filing contract comprises one or more among bibliographic information of related IP Info, identification information of applicant, terms of contract, rewards to counterpart contractor, application filing fee, court at dispute, etc.

81. The method of one of claims 51 to 63 wherein said electronic commerce relates to dealing of specific IP Info, exchange with other IP, exchange with other license, transferring denomination of ownership, transferring patent ownership, transferring partial patent ownership and/or contract for filing international patent application, etc.

82. The method of one of claims 44 to 63 wherein the document form of said IP Info written in English or the language of the requested country for filing patent application is like PCT patent application.

83. The method of one of claims 44 to 63 wherein the important information is transmitted in encrypted format between said user terminal and said service system.

84. The method of one of claims 44 to 63 wherein said user terminal is equipped with various computer programs executing on Internet based computer, officially-approved user digital certificate, electronic signature and encryption means; said electronic signature and encryption means is downloaded from said service system and is installed in itself.

85. The method of one of claims 44 to 63 further comprising the step of providing user with the customized language version interface display file in one of the following ways after user connects with said service system:
(a) the way in which said service system provides user with the first interface display file in default language version, then provides said customized language version interface display file after verifying user's language use information stored in said storage device through the log-on means of said first interface display file;
(b) the way in which said service system directly provides said customized language version interface display file after verifying user's default language use information of the attribute information file stored in predetermined section of the storage device of said user terminal.
(c) the way in which said service system directly provides said customized language version interface display file after verifying user's default language use information of said attribute information file including user's language use classification code;
wherein said attribute information file comprises cookie file.

86. The method of one of claims 48 to 50 wherein said non-disclosed IP Info and said filed patent application information to be sent or received are encoded into encrypted format codes and are decoded into original format document by said terminals of user and cooperative company respectively.

87. The method of claim 86 wherein said non-disclosed IP Info is encoded into encrypted format codes using public key of the requested country cooperative company and said filed application information is encoded into encrypted format codes using public key of related user.

88. A computer-readable storage medium containing the computer program for controlling the operation of computer processor in computer system to execute the method of one of claims 44 to 50.

89. A computer-readable storage medium containing the computer program for controlling the operation of computer processor in computer system to execute the method of one of claims 51 to 87.
